(19) United States
(12) Patent Application Publication
(10) Pub. No.: US 2006/0269214 A1
(43) Pub. Date: Nov. 30, 2006

(54) Light management films of differing refractive indices

(76) Inventor: Ronald J. Sudol, Rochester, NY (US)

Correspondence Address: Patent Legal Staff;Eastman Kodak Company, 343 State Street, Rochester, NY, 14650-2201, US

(21) Appl. No.: 11/501,398

(22) Filed: Aug. 9, 2006

Related U.S. Application Data
(63) Continuation-in-part of application No. 11/056,455, filed on Feb. 11, 2005.

(51) Int. Cl. G02B 6/10

(52) U.S. Cl. 385/146

(57) ABSTRACT

An optical layer includes a first light management film having a first index of refraction (n₁) and a second light management film having a second index of refraction (n₂). The first index of refraction and the second index of refraction are not the same, and a plurality of optical features is disposed over each of the light management films. A light management film is also disclosed.

### CROSS-REFERENCE TO RELATED APPLICATIONS

This application is a Continuation-in-Part of U.S. Ser. No. 11/056,455 filed on Feb. 11, 2005, the contents of which are incorporated herein.

### BACKGROUND

Light valves are implemented in a wide variety of display technologies. For example, display panels that incorporate light valve arrays are gaining in popularity in many applications such as televisions, computer monitors, point of sale displays, personal digital assistants and electronic cinema to mention only a few applications.

Many light valves are based on liquid crystal (LC) technologies. Some of the LC technologies are based on transmittance of the light through the LC device (panel), while others are based on the light's traversing the panel twice, after being reflected at a far surface of the panel.

An external field or voltage is used to selectively rotate the axes of the liquid crystal molecules. As is well known, by application of a voltage across the LC panel, the direction of the LC molecules can be controlled and the state of polarization of the transmitted light may be selectively changed. As such, by selective switching of the transistors in the array, the LC medium can be used to modulate the light with image information. Often, this modulation provides dark-state light at certain picture elements (pixels) and bright-state or attenuated light at others, where the polarization state governs the state of the light. Thereby, an image is created on a screen by the selective polarization transformation by the LC panel and optics to form the image or ‘picture.’

As is known, the light source (often referred to as a backlight unit) for the display is a source of substantially white light. The light from the source may be incident on a light management film. Light management films are often used in light valve-based displays to modify and to control the angular distribution of light emitted from a backlight unit. Such light management films often include prismatic features or discrete optical elements, which are useful in directing light from the backlight unit to the light-valve and other components of the display device.

While known light management films provide certain benefits in display applications, there are known drawbacks and shortcomings. These drawbacks include poor light utilization efficiency, limited on-axis gain, and inflexible control of angular light distribution to name only a few.

What is needed, therefore, is a light management film that addresses at least the shortcomings and drawbacks of known structures referenced above.

### SUMMARY OF THE INVENTION

In accordance with an example embodiment, an optical layer includes a first light management film having a first index of refraction (n₁) and a second light management film having a second index of refraction (n₂). The first index of refraction and the second index of refraction are not the same. A plurality of optical features is disposed over each of the light management films.

In accordance with another example embodiment, a display device includes a light management layer comprising a first light management film having a first index of refraction (n₁) and a second light management film having a second index of refraction (n₂). The first index of refraction and the second index of refraction are not the same. A plurality of optical features is disposed over one or more surfaces of each of the light management films.

### BRIEF DESCRIPTION OF THE DRAWINGS

FIGS. 1a1-1a2 are cross-sectional views of a display system incorporating a light valve in accordance with example embodiments.

FIGS. 1b-1k are cross-sectional views of light management layers accordance with example embodiments.

FIG. 11 is the xyz coordinate system indicating polar angle, θ, and the azimuthal angle, ∅, applicable to radiant intensity graphs.

FIGS. 2a-2h are graphical representations of radiant light intensity versus angle, of light management layers in accordance with example embodiments.

FIGS. 3a-3f are reverse ray traces of light management layers in accordance with example embodiments.

FIGS. 4a-4l are graphical representations of radiant light intensity versus angle, of light management layers in accordance with example embodiments.

FIGS. 5a-5h are graphical representations of radiant light intensity versus angle, of light management layers in accordance with example embodiments.

FIGS. 6a-6b are graphical representations of radiant light intensity versus angle, of light management layers in accordance with example embodiments.

FIGS. 7a-7d are graphical representations of radiant light intensity versus angle, of light management layers in accordance with example embodiments.

FIGS. 8a-8b are graphical representations of radiant light intensity versus angle of light management layers in accordance with example embodiments.

FIGS. 9a-9b are graphical representations of radiant light intensity versus angle of light management layers in accordance with example embodiments.

FIGS. 10a-10b are graphical representations of radiant light intensity versus angle of light management layers in accordance with example embodiments.

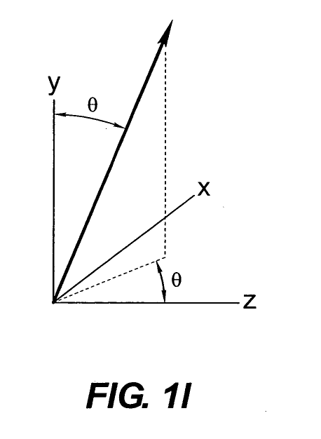

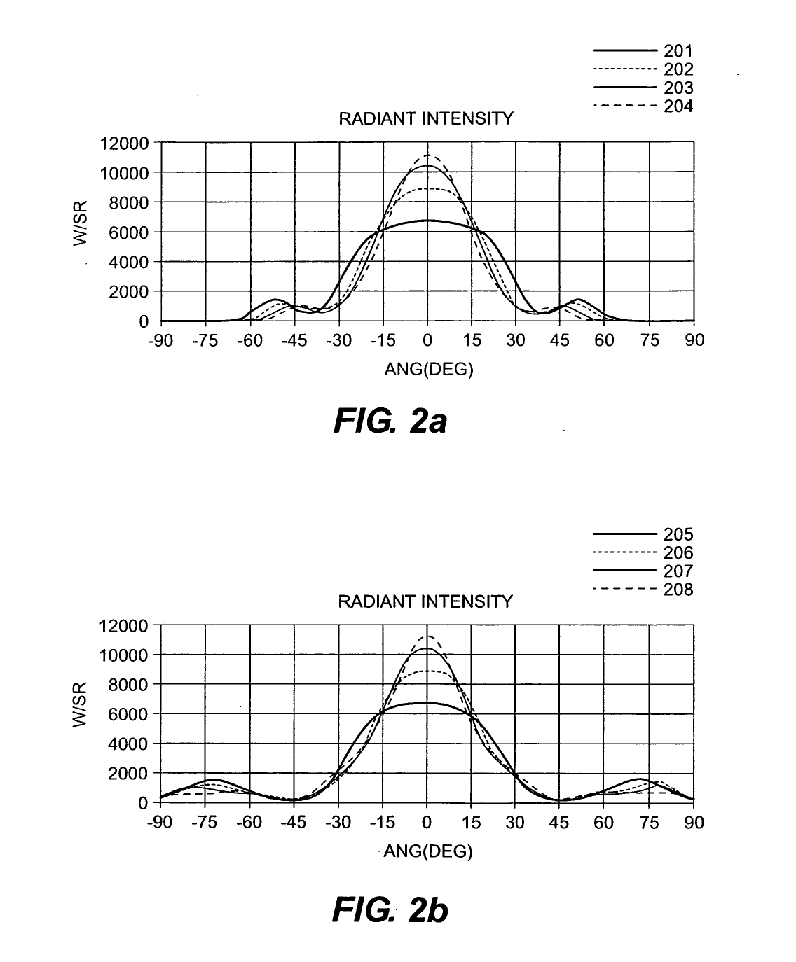

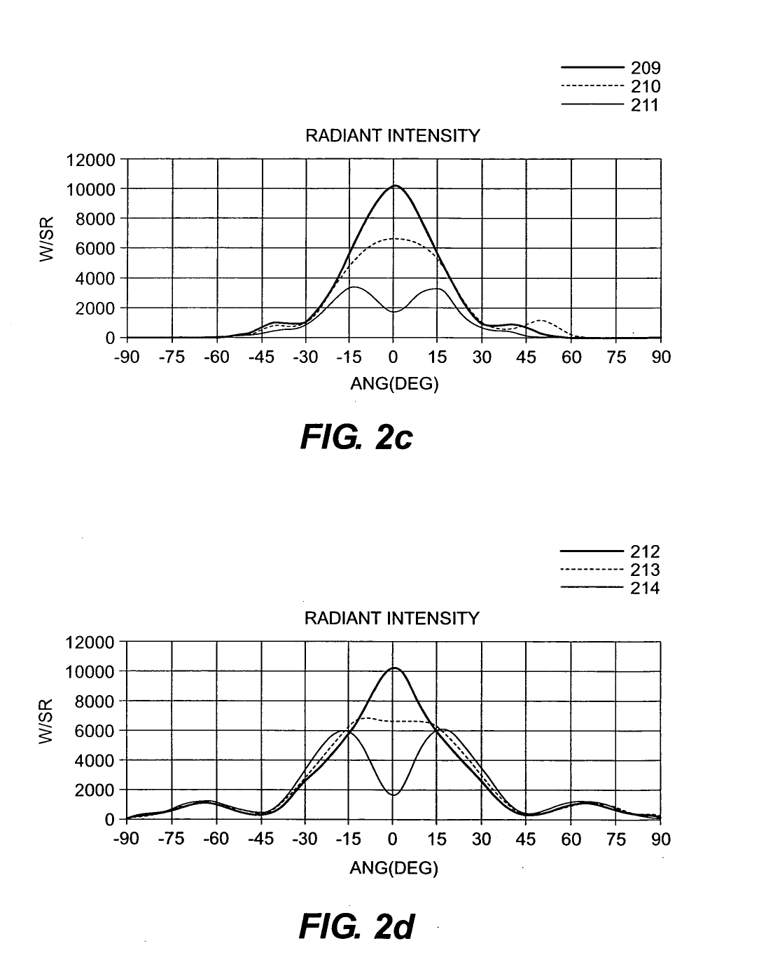

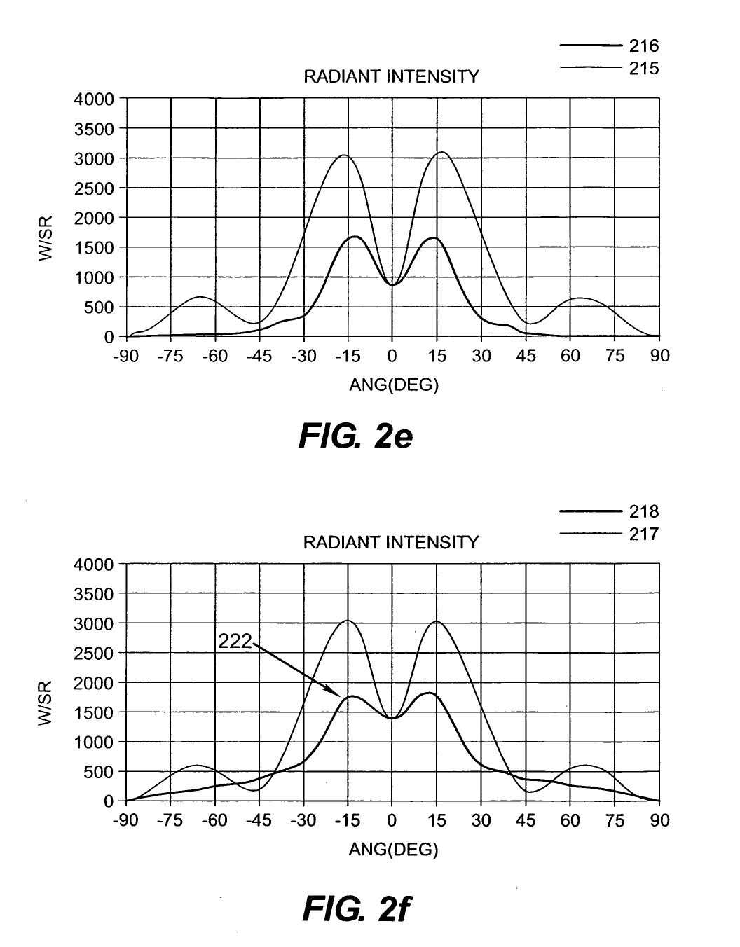

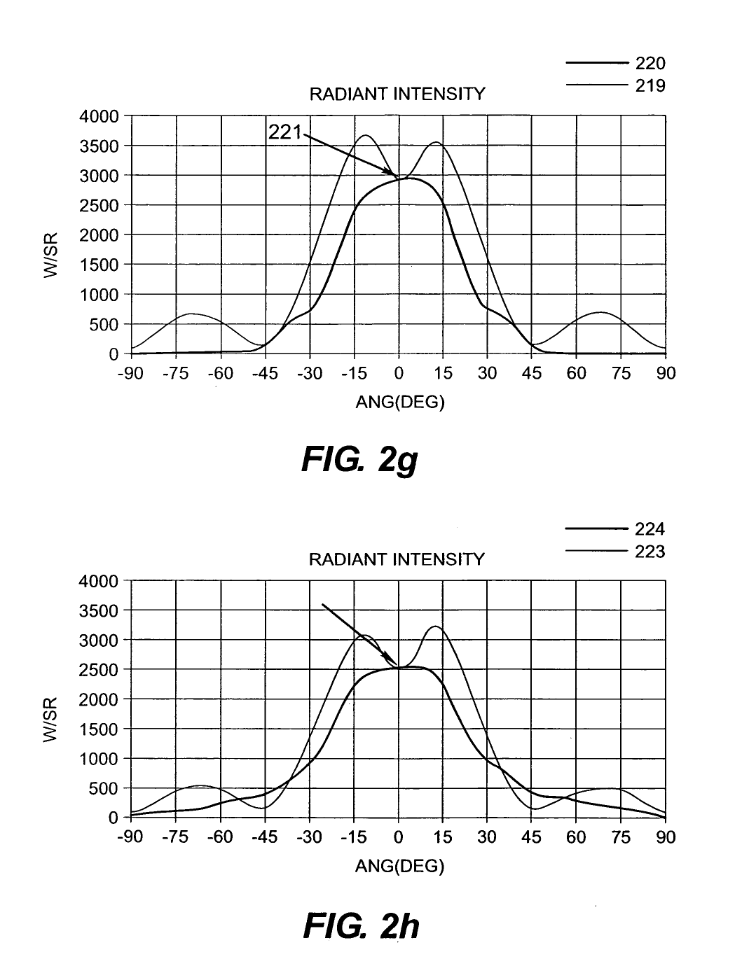

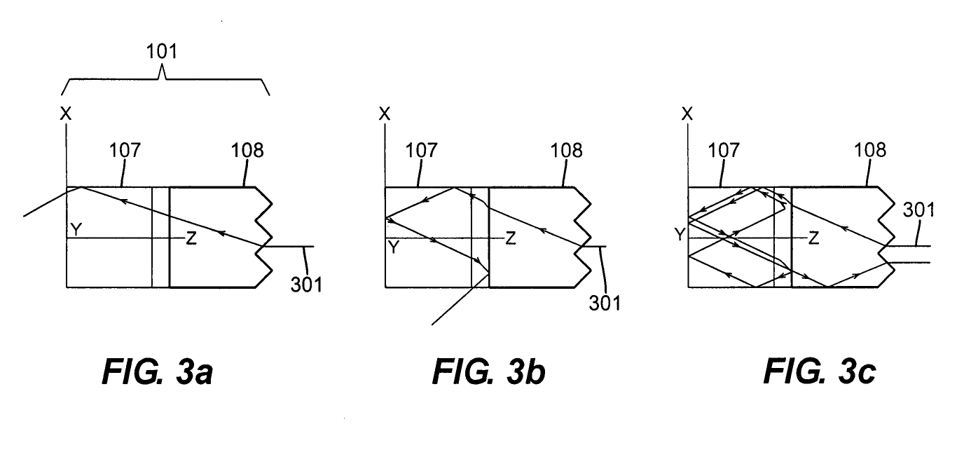

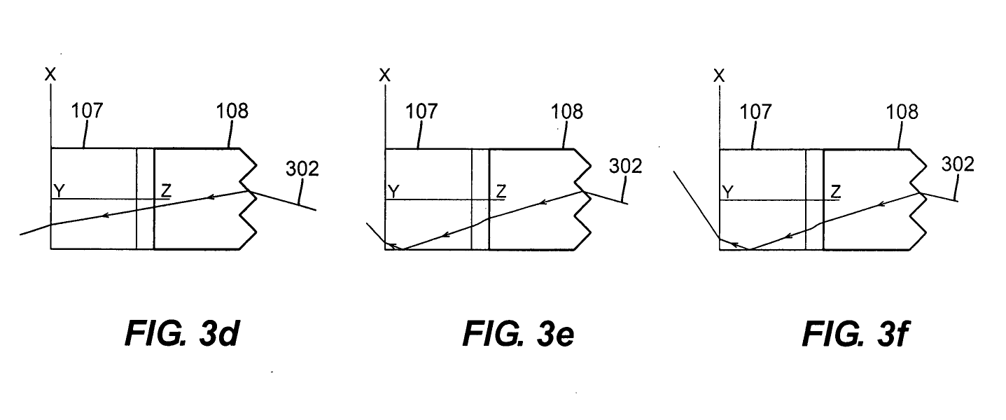

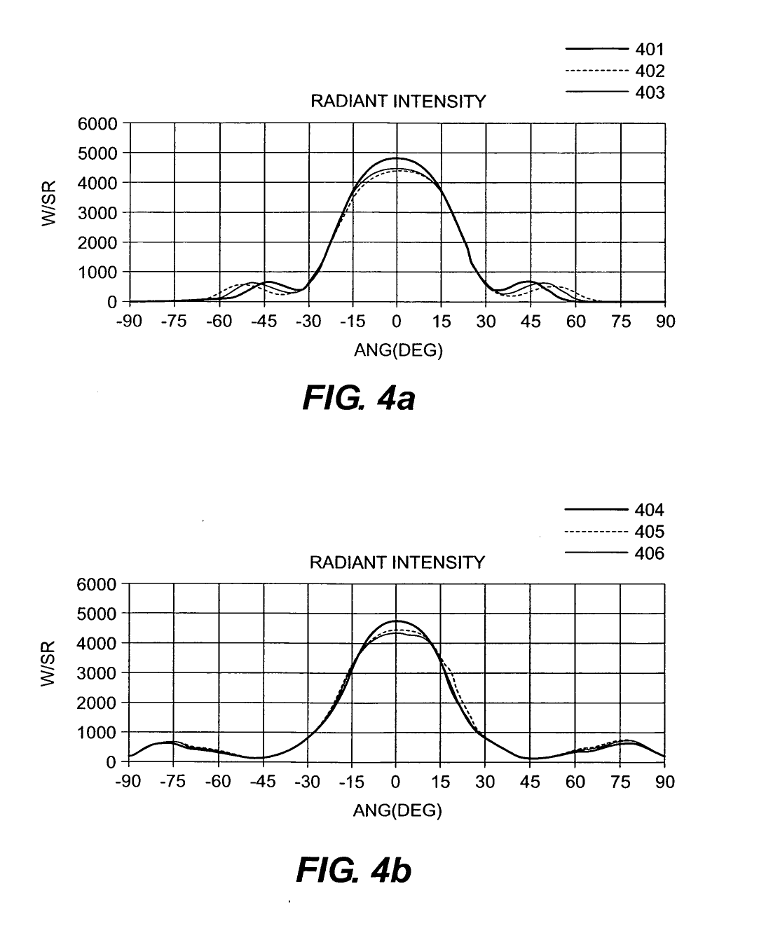

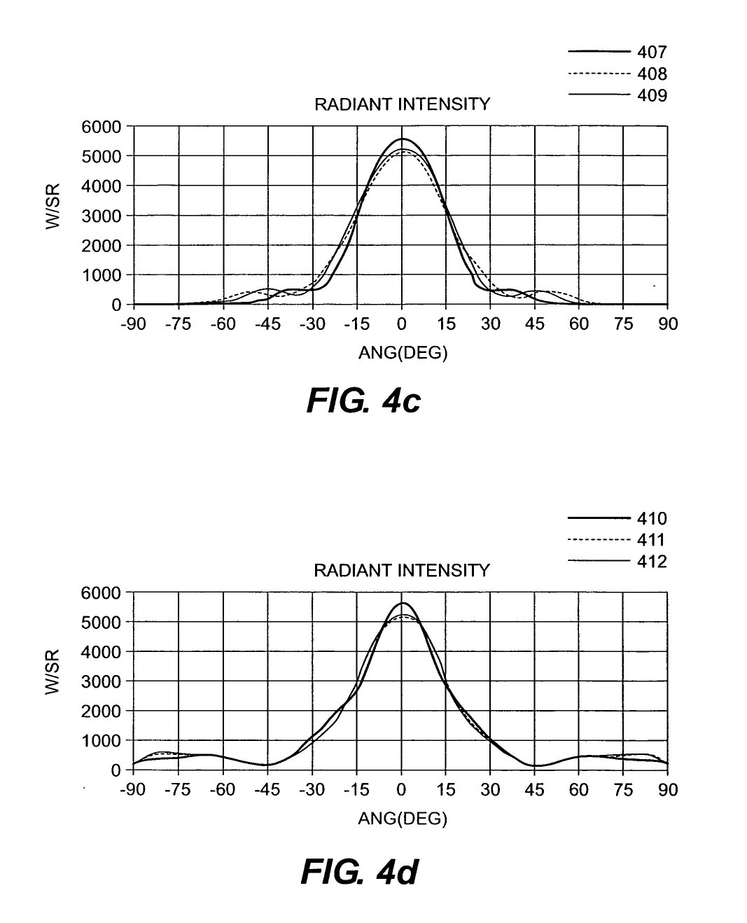

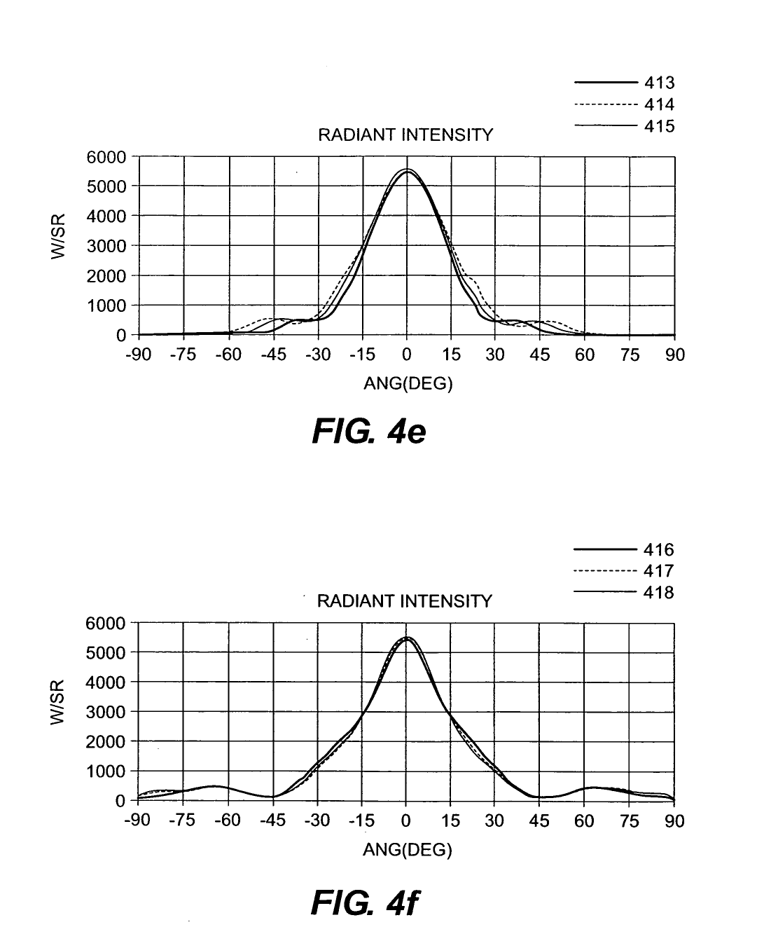

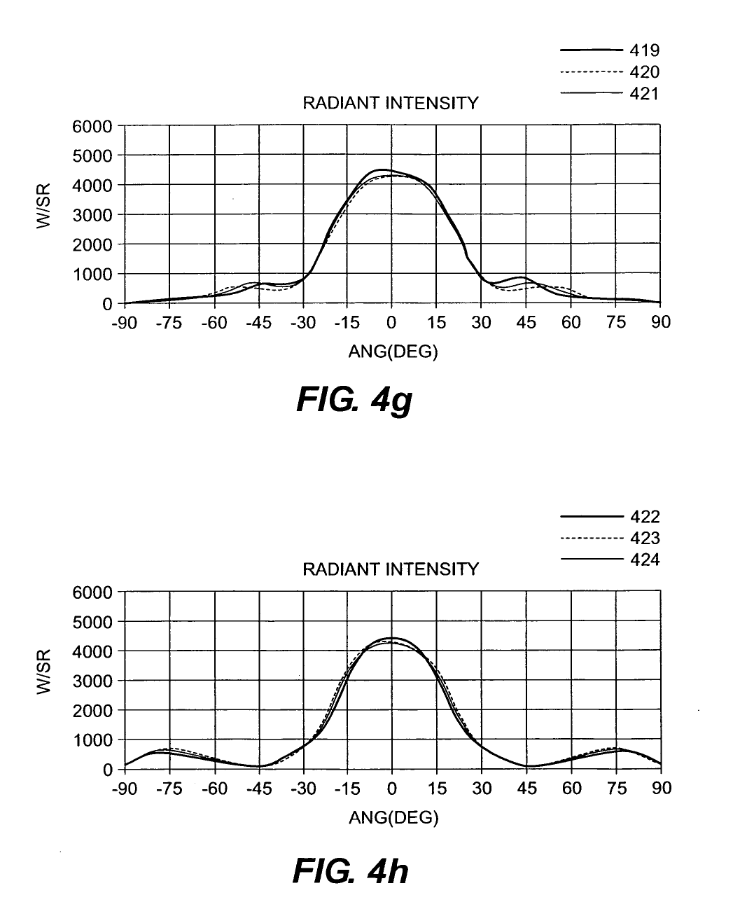

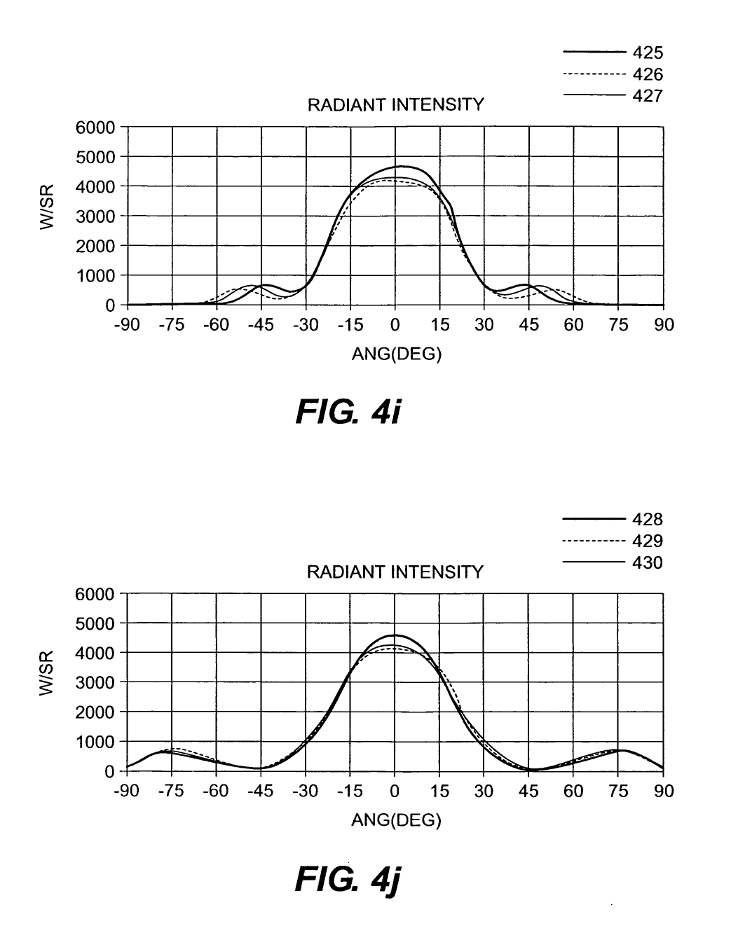

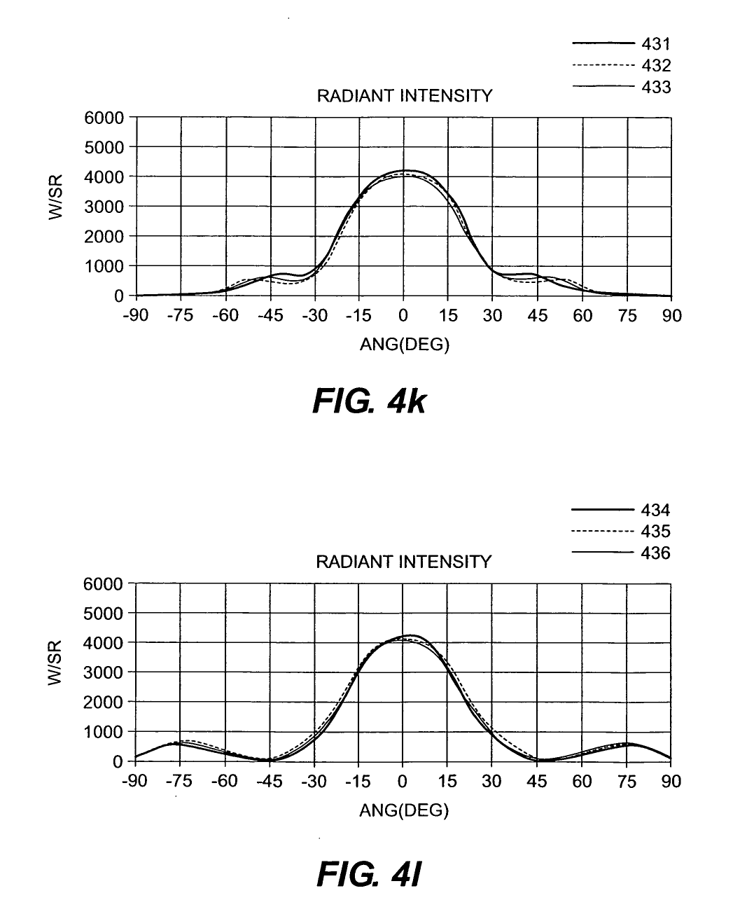

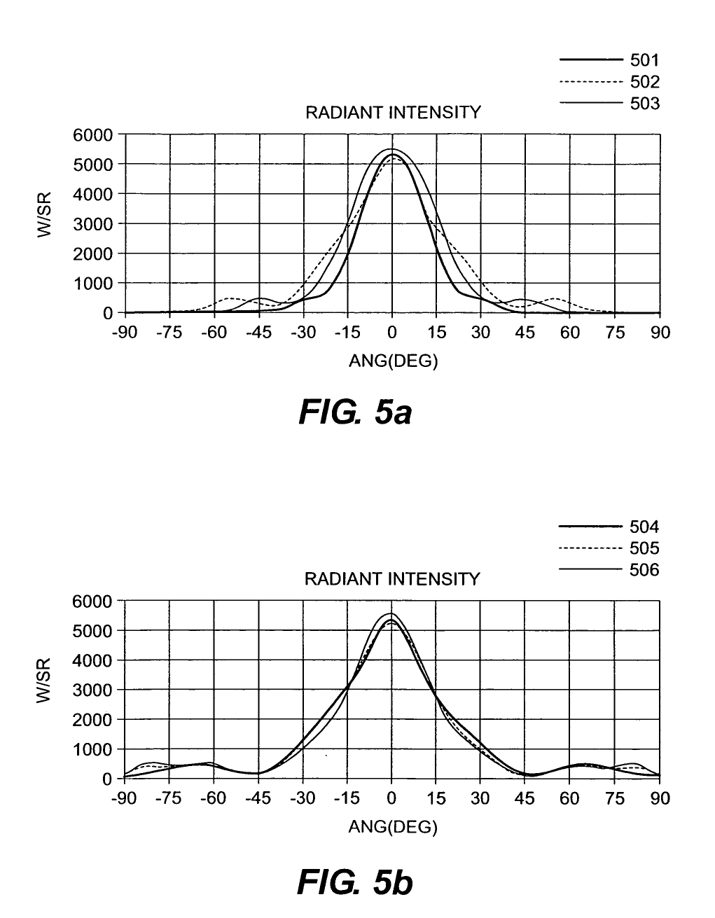

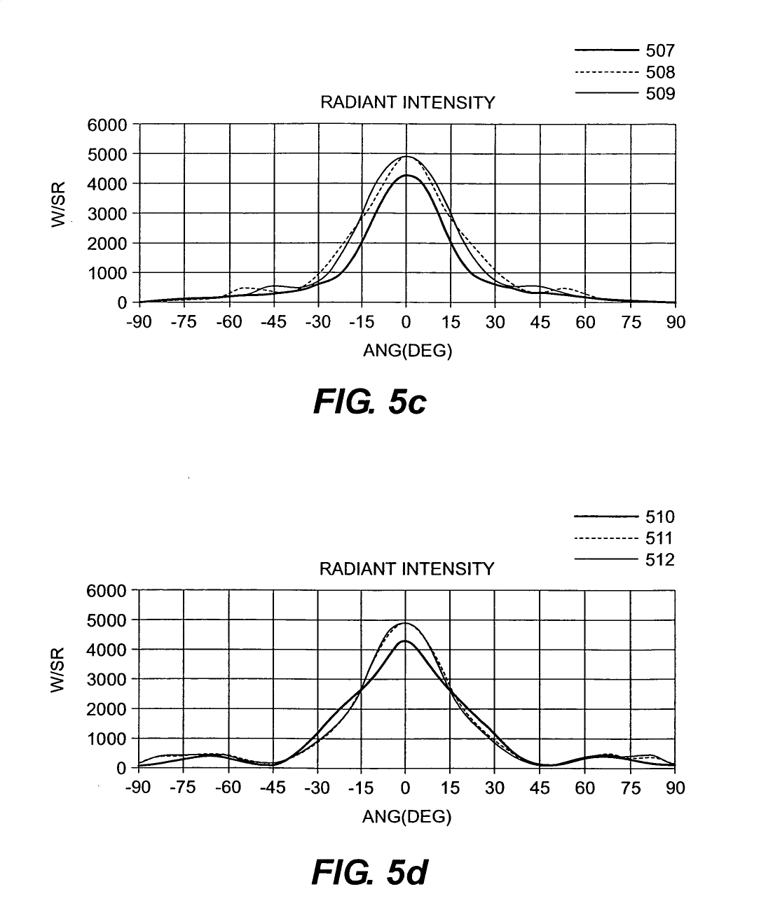

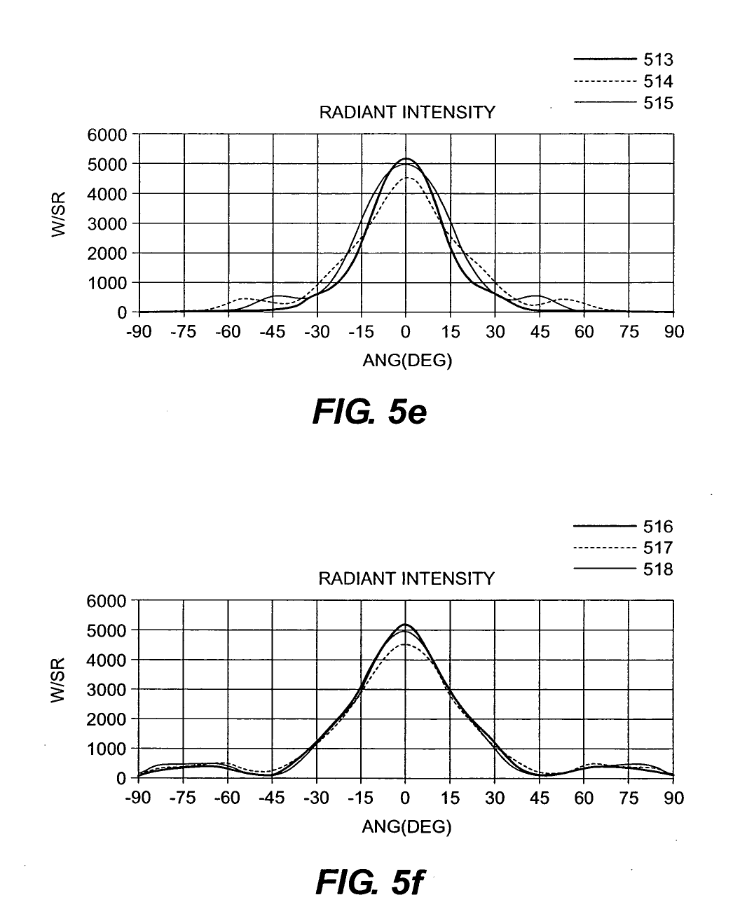

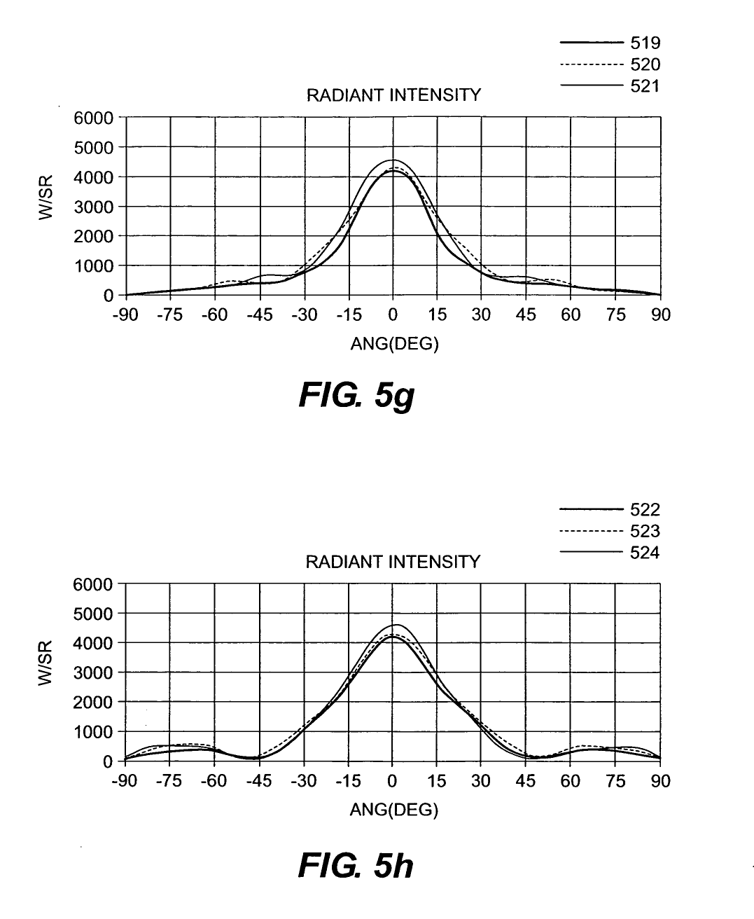

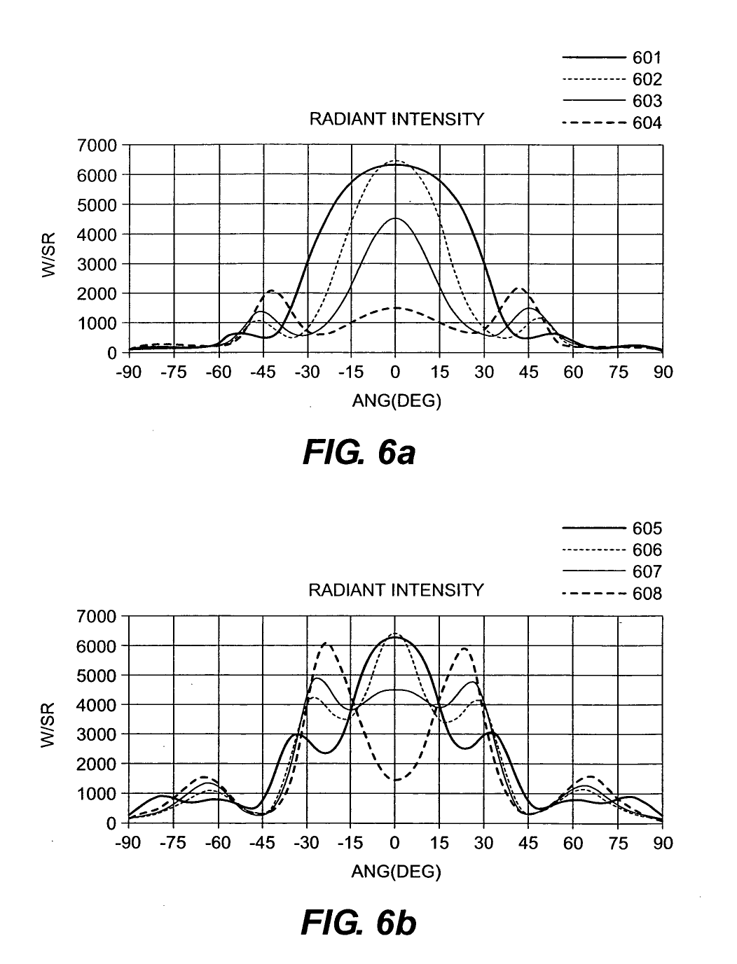

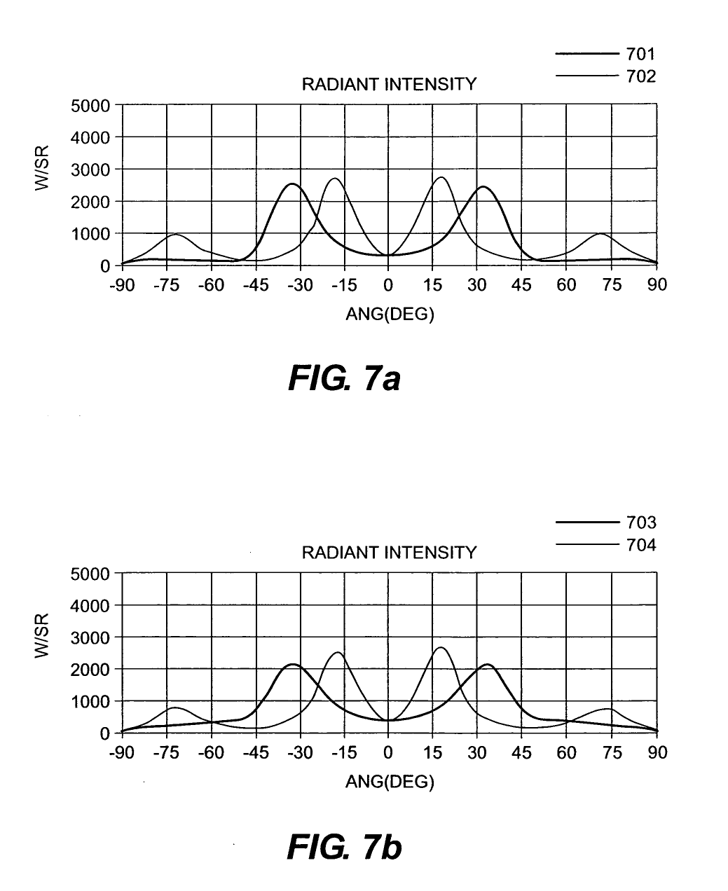

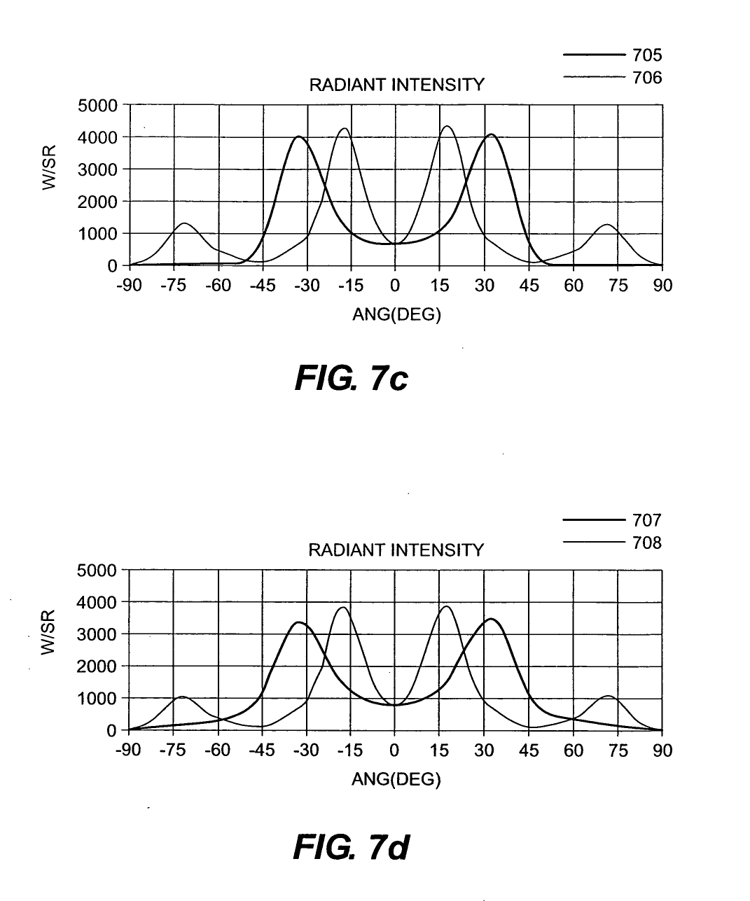

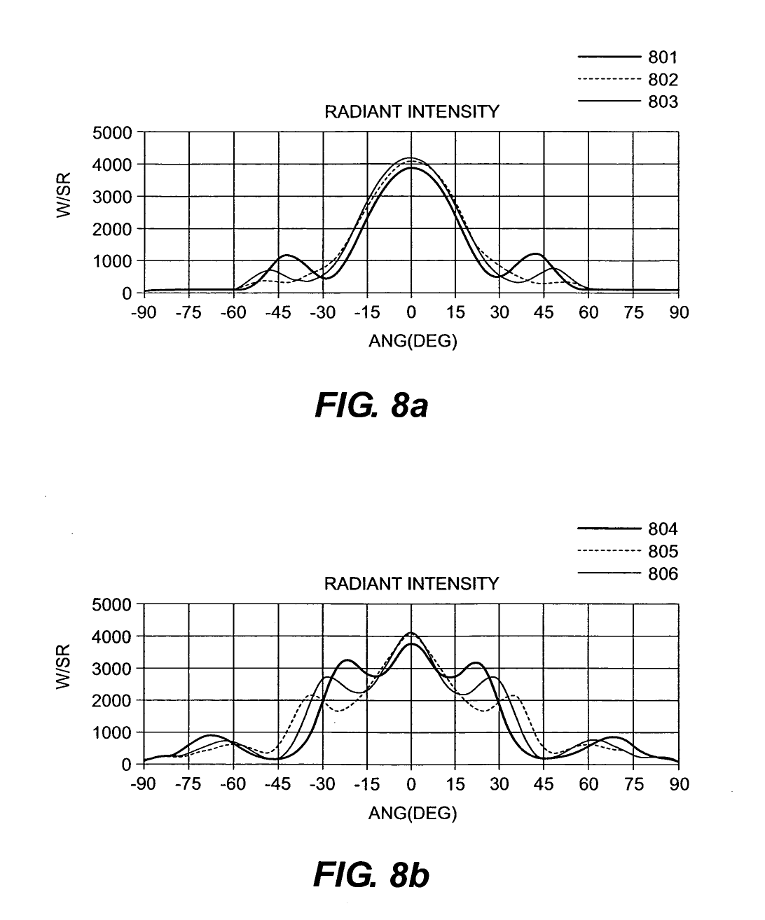

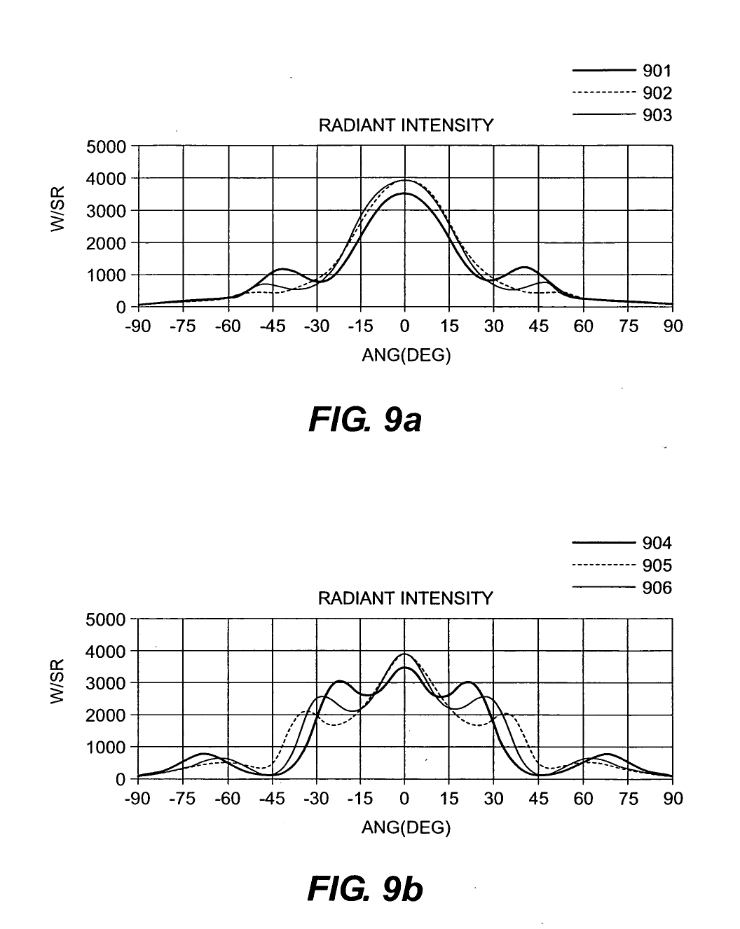

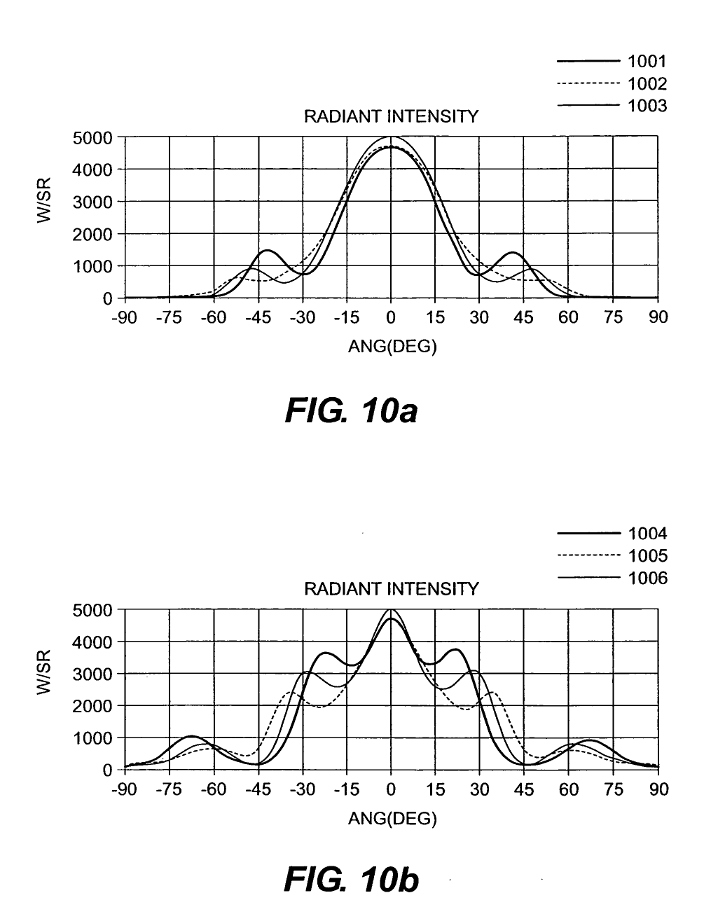

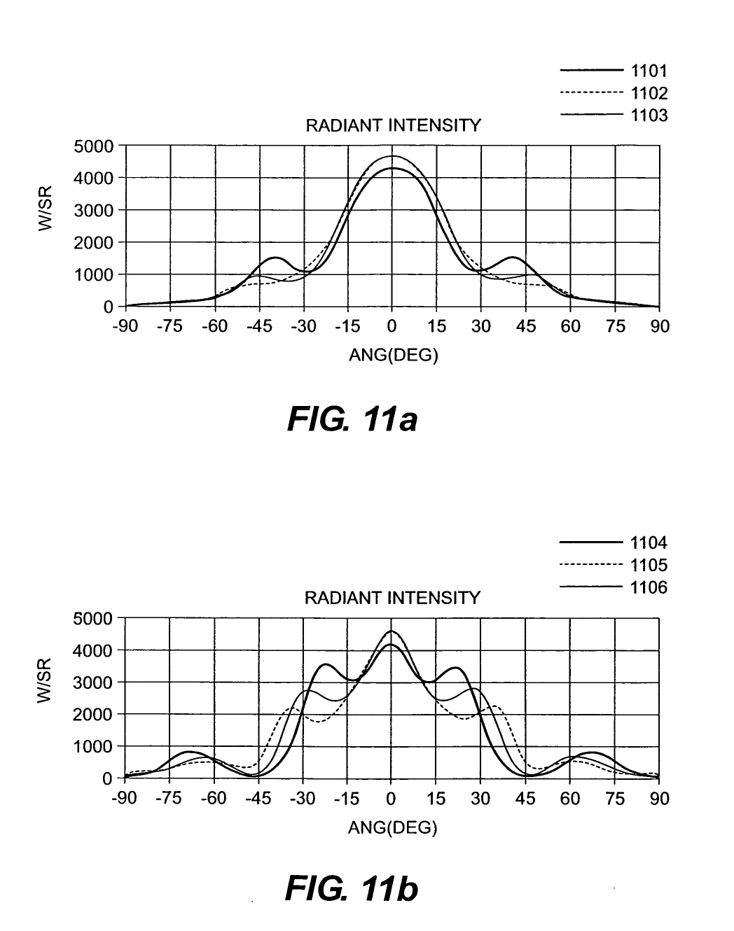

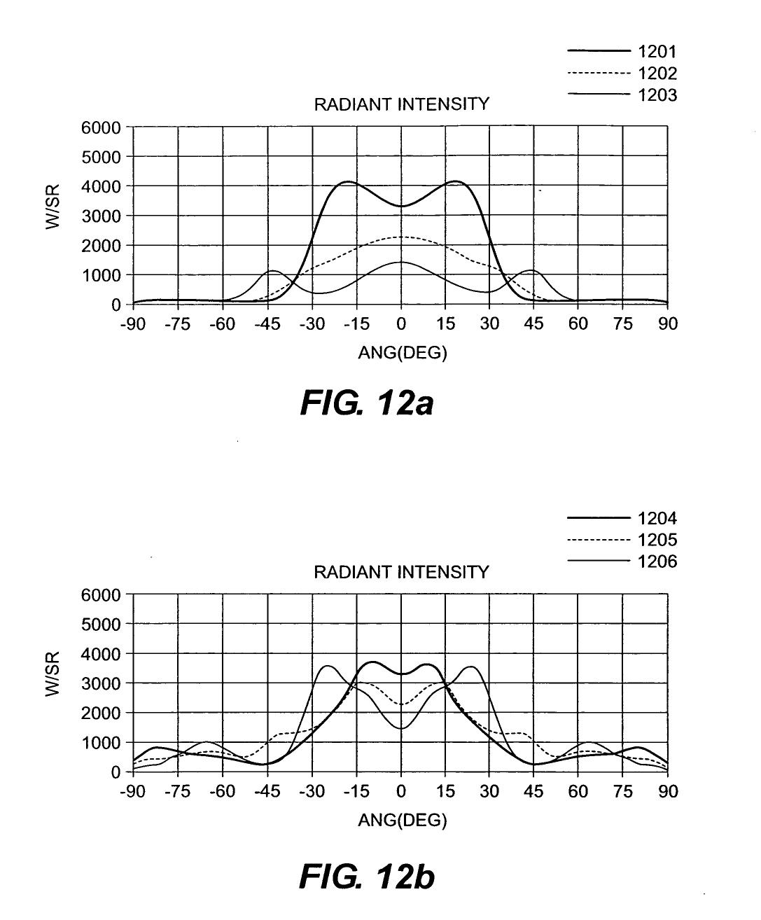

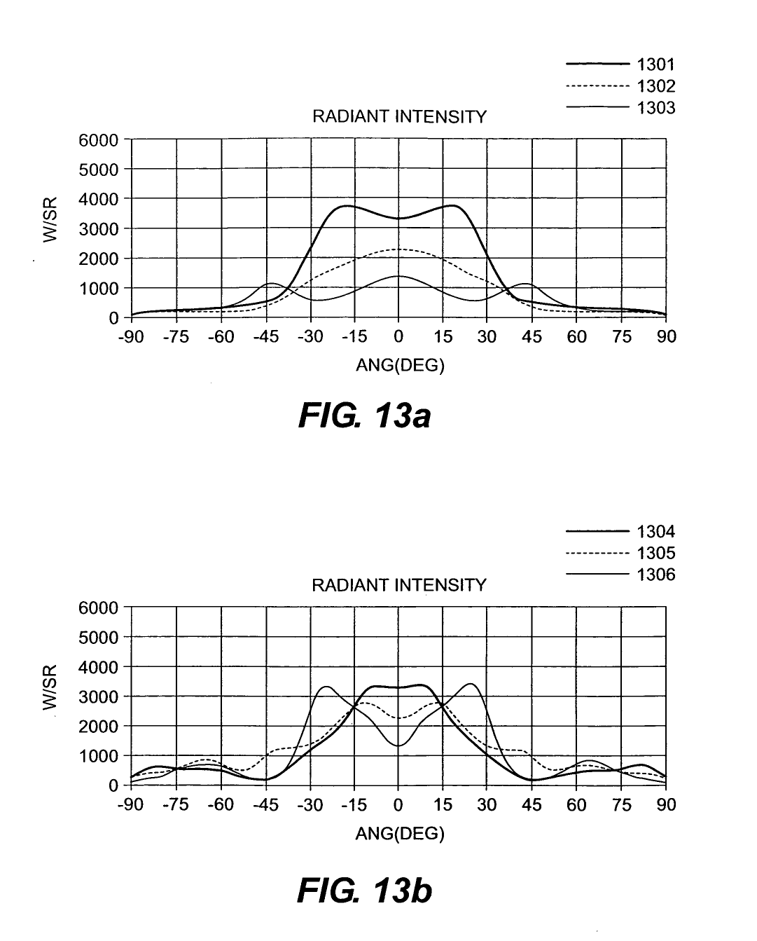

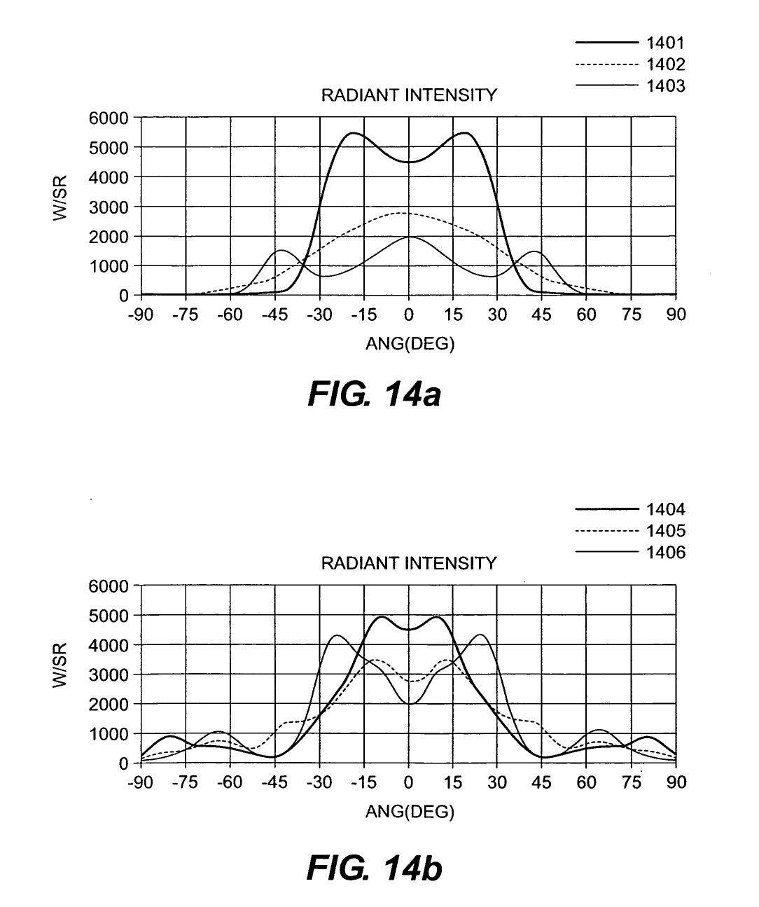

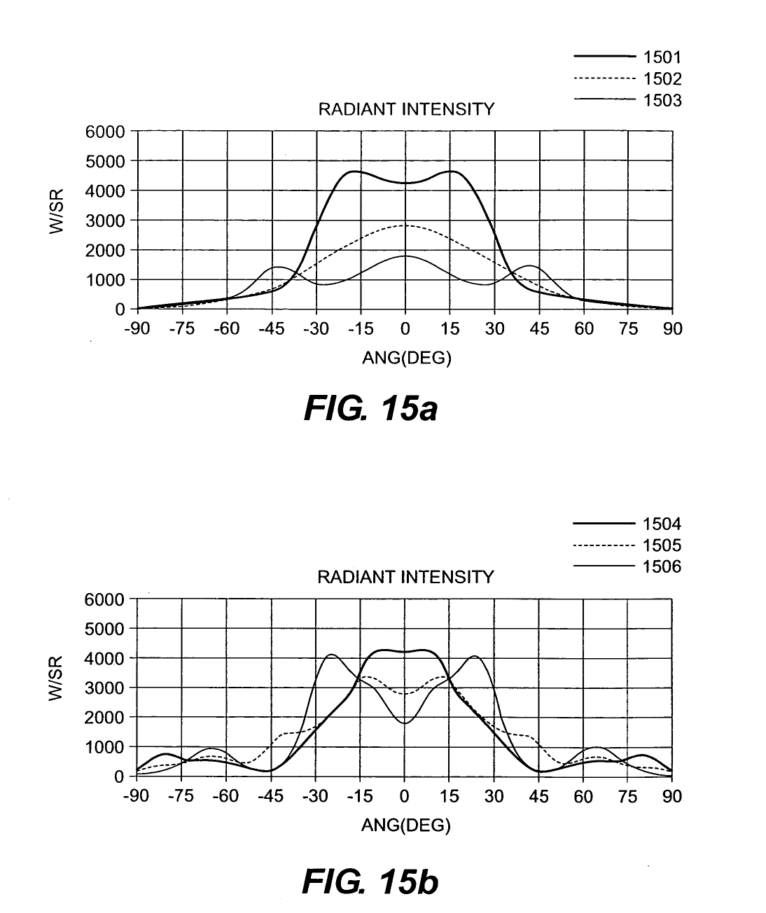

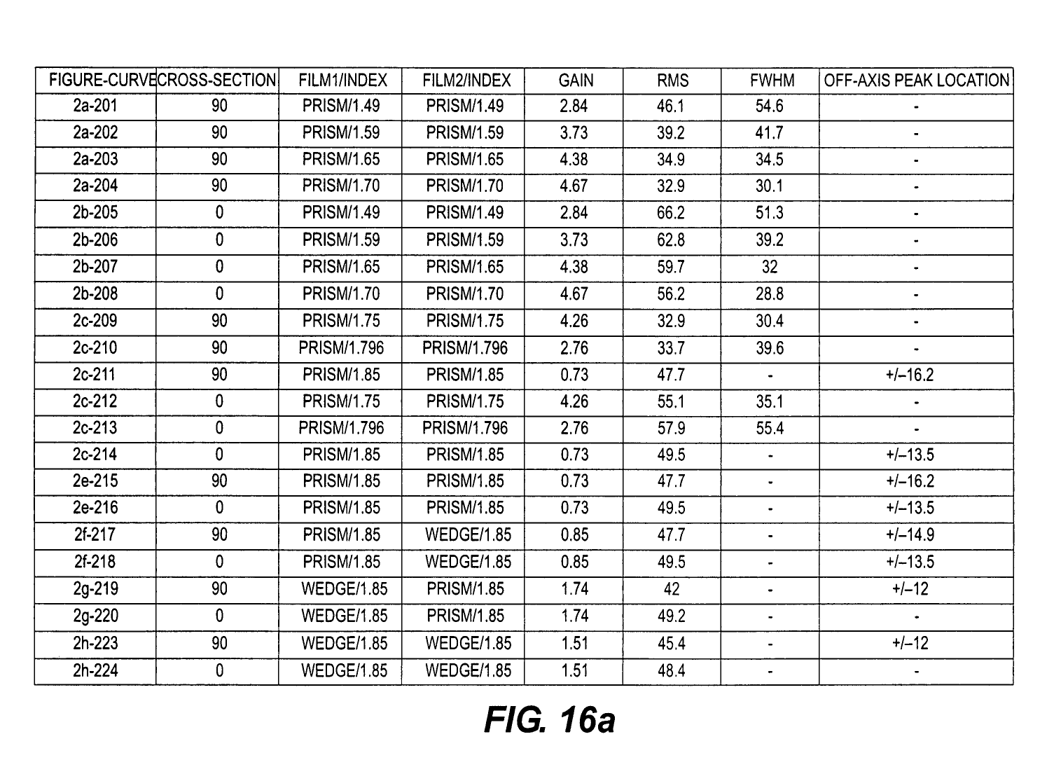

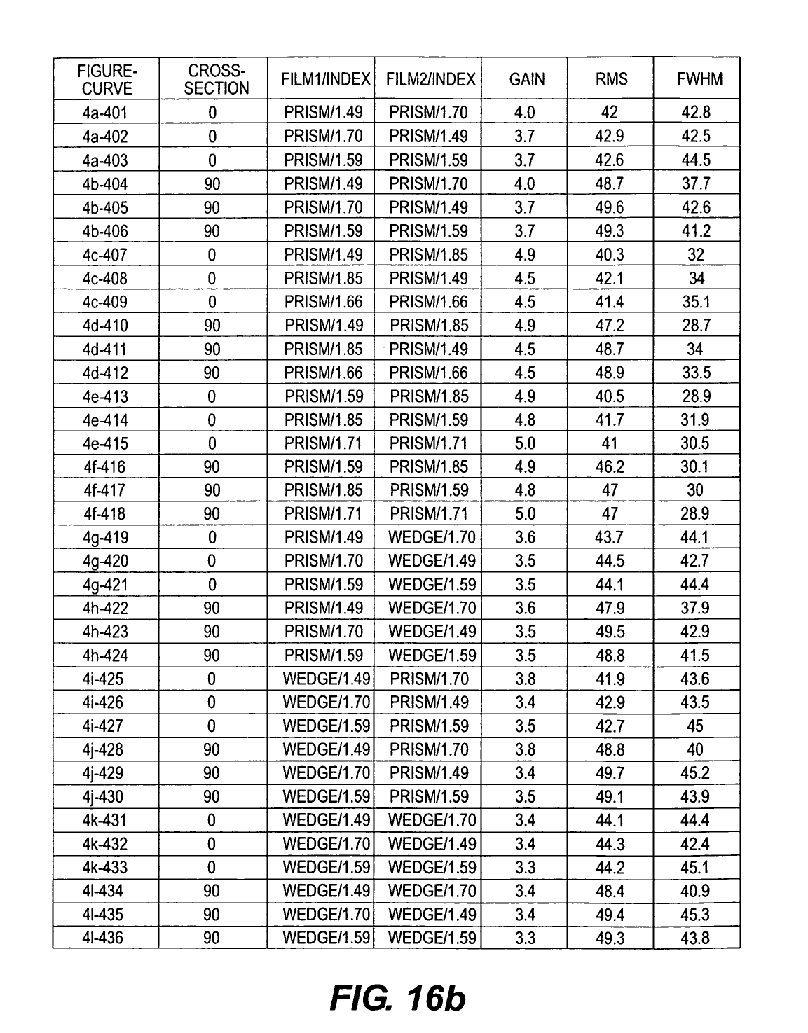

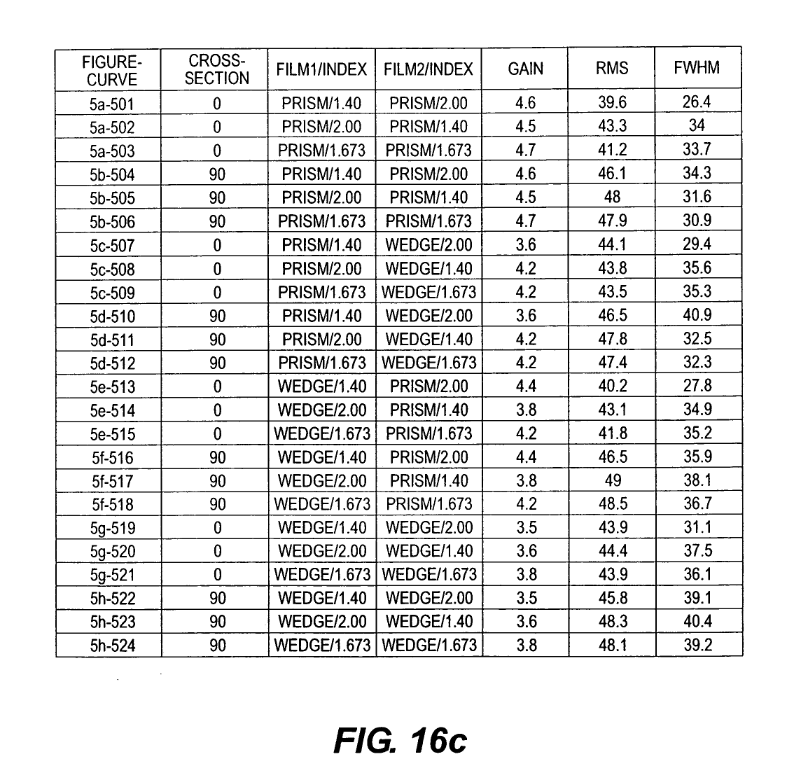

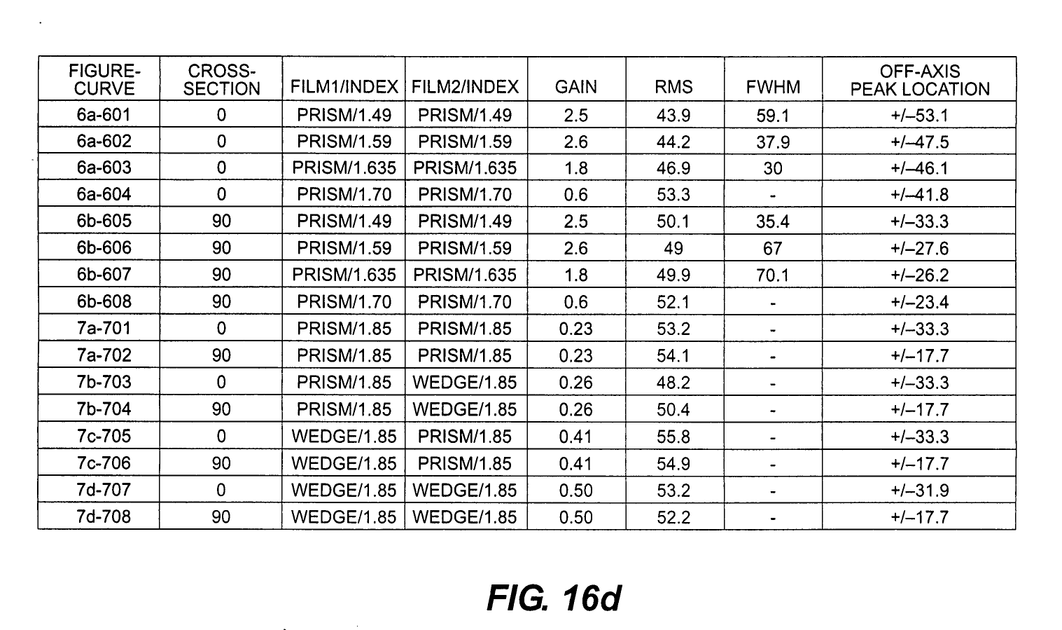

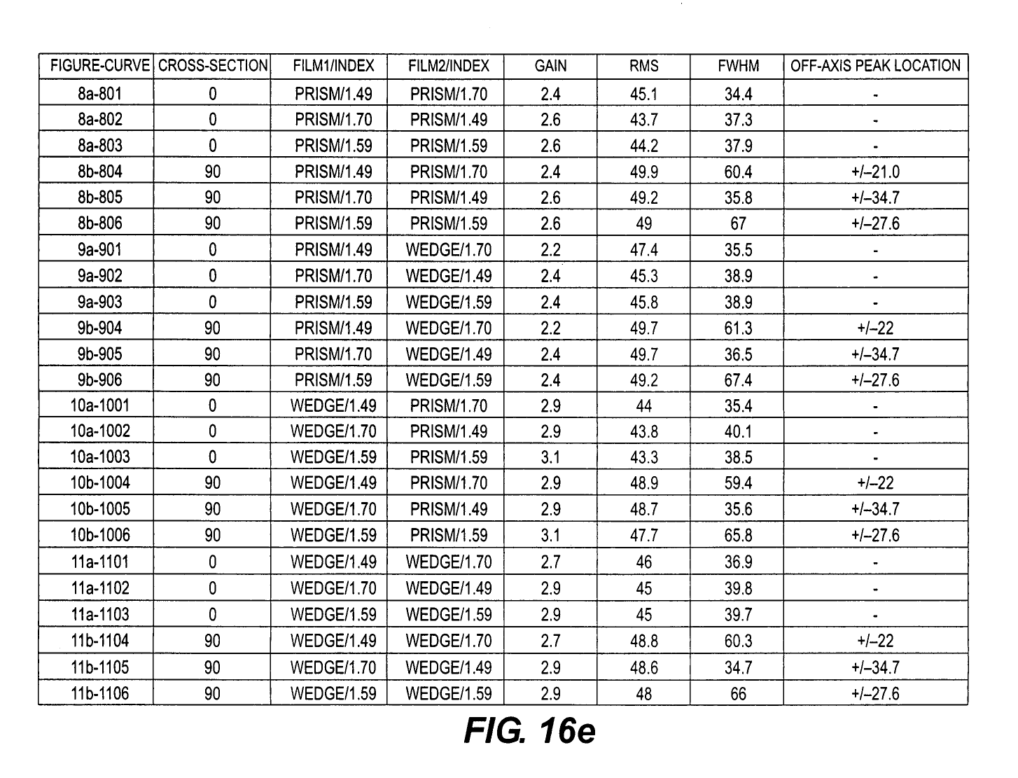

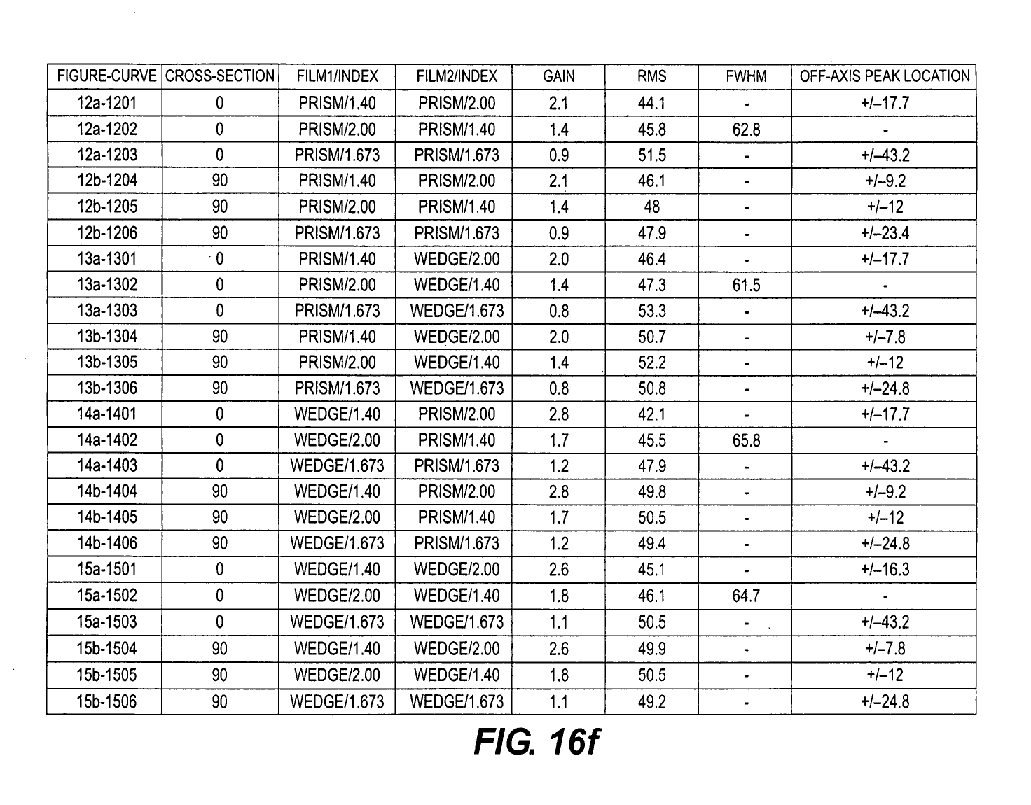

FIGS. 11a-11b are graphical representations of radiant light intensity versus angle of light management layers in accordance with example embodiments.

FIGS. 12a-12b are graphical representations of radiant light intensity versus angle of light management layers in accordance with example embodiments.

FIGS. 13a-13b are graphical representations of radiant light intensity versus angle of light management layers in accordance with example embodiments.

FIGS. 14a-14b are graphical representations of radiant light intensity versus angle of light management layers in accordance with example embodiments.

FIGS. 15a-15b are graphical representations of radiant light intensity versus angle of light management layers in accordance with example embodiments.

FIG. 16a is a tabular representation (Table 1) of data garnered using a light management layer in accordance with an example embodiment.

FIG. 16b is a tabular representation (Table 2) of data garnered using a light management layer in accordance with an example embodiment.

FIG. 16c is a tabular representation (Table 3) of data garnered using a light management layer in accordance with an example embodiment.

FIG. 16d is a tabular representation (Table 4) of data garnered using a light management layer in accordance with an example embodiment.

FIG. 16e is a tabular representation (Table 5) of data garnered using a light management layer in accordance with an example embodiment.

FIG. 16f is a tabular representation (Table 6) of data garnered using a light management layer in accordance with an example embodiment.

### DEFINED TERMINOLOGY

1. As used herein, “transparent” includes the ability to pass radiation without significant scattering or absorption within the material. In accordance with illustrative embodiments, “transparent” material is defined as a material that has a visible spectral transmission greater than 90%.

2. As used herein, the term “light” means visible light.

3. As used herein, the term “polymeric film” means a film comprising polymers; and as used herein the term “polymer” means homopolymers, co-polymers, polymer blends, and organic/inorganic materials.

4. As used herein, the terms “optical gain”, “on axis gain”, or “gain” mean the ratio of output light intensity in a given direction, where the given direction is often normal to the plane of the film, divided by input light intensity in the same direction. To wit, optical gain, on-axis gain and gain are used as a measure of the performance of a redirecting film and can be utilized to compare the performance of light redirecting films. 5. As used herein, the term “curved surface” indicates a three dimensional feature on a film that has curvature in at least one plane.

6. As used herein, the term “wedge-shaped features” indicates an element that includes one or more sloping surfaces, and these surfaces may be combination of planar and curved surfaces.

7. As used herein, the term “optical film” indicates a relatively thin polymer film that changes the nature of transmitted incident light. For example, a redirecting light management film of an example embodiment provides an optical gain (output/input) greater than 1.0.

8. As used herein, the term “effective refractive index” indicates an index of refraction that equals the geometric mean of two indices n₁ and n₂ where n₁ does not equal n₂. Specifically, the effective refractive index is given by: (n₁×n₂)^{1/2}.

9. As used herein, the term 0 degree or vertical cross-section of the radiant intensity distribution means the section taken along azimuthal angle, ∅, equal 0 and polar angle, θ, ranging from −90 to +90.

10. As used herein, the term 90 degree or horizontal cross-section of the radiant intensity distribution means the section taken along azimuthal angle, ∅, equal 90 and polar angle, θ, ranging from −90 to +90. See FIG. 11 for coordinate system.

11. As used herein, the term “light management film” means an optical film having optical features disposed over one or both film surfaces, wherein the optical features comprise sloping surfaces that comprise shapes such as prisms and wedges to redirect the light preferentially toward the light valve array. The light management film receives light through one surface and emits it primarily through the second surface. When used with an electronic display, light emitted through the second surface is directed primarily by reflection and refraction towards the light modulating element (light valve array, for example) of the display. As used herein, “light management films” do not redirect light primarily by either scatter or diffraction. In addition, “light management films” do not produce substantially Lambertian light distributions.

### DETAILED DESCRIPTION OF THE INVENTION

In the following detailed description, for purposes of explanation and not limitation, example embodiments disclosing specific details are set forth. However, it will be apparent to one having ordinary skill in the art having had the benefit of the present disclosure that other embodiments may be realized that depart from the specific details disclosed herein. Such embodiments are within scope of the appended. Moreover, descriptions of well-known apparati and methods may be omitted so as to not obscure the description of the present invention. Such methods and apparati are clearly within the contemplation of the inventors in carrying out the example embodiments.

Briefly, the example embodiments described herein relate to light management films having at least two layers. A first film has a first index of refraction, and a second film has a second index of refraction, where the first and second indices of refraction are not the same. To wit, in certain example embodiments, first index of refraction is greater than the second index of refraction; and in other example embodiments the second index of refraction is greater than the first index of refraction. The use of the different indices is shown to preserve the high on-axis gain. Moreover, both films include optical features on at least one surface.

Through example embodiments, it is shown that the order of use of the films of differing refractive index can produce a change in the angular field. This is an unexpected result not disclosed earlier in the literature; the simple change in order of two light management films of differing refractive index is sufficient to alter the angular field of view of a display without significantly altering the efficiency. Illustratively, this benefits a display assembly house for it is able to purchase films with two refractive indices, index H (high) and index L (low), and manufacture at least four differently performing displays.

As described more fully in connection with the certain example embodiments herein, the first index of refraction, the second index of refraction and the order of the films are selected to tailor a desired angular distribution of light. This ordering of the films and their indices of refraction can be chosen to provide a desired on-axis gain and angular distribution of the light exiting the management films. In display applications these characteristics benefit the brightness and contrast of the image, and the angular field of view of the display, respectively. Alternatively, this ordering of the films and their indices of refraction can be selected to reduce the on-axis gain and to provide lobes of significant light intensity substantially about a line of symmetry through center angle.

The light management films of the example embodiments are described in connection with display devices. Such devices often include a light valve such as an LCD light valve, a liquid crystal on silicon (LCOS) light valve or a digital light processing (DLP) light valve. It is emphasized that the light management films of the example embodiments have utility in many other applications. For example, the light management films of the example embodiment have utility in lighting applications where it is useful to direct light in a semi-custom fashion (semi-custom can mean where one starts with a “universal” light source where the direction of light is altered through the use of the light management films). Illustratively, the light management films of the example embodiments are useful in lighting applications including lighting panels for room lighting; similarly for solid-state lighting panels. For example, the light management films may be used in conjunction with LED light sources in a variety of applications including automotive and traffic lighting. It is emphasized that the noted applications of the light management films of the example embodiments is merely illustrative, and not limiting.

Specific details will now be set forth with respect to example embodiments depicted in the attached drawings. It is noted that like reference numerals refer to like elements.

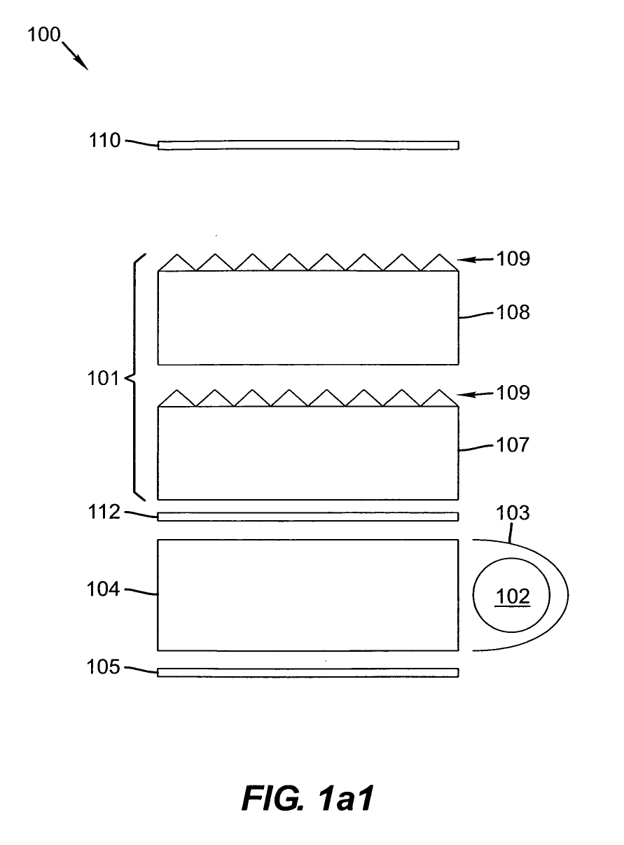

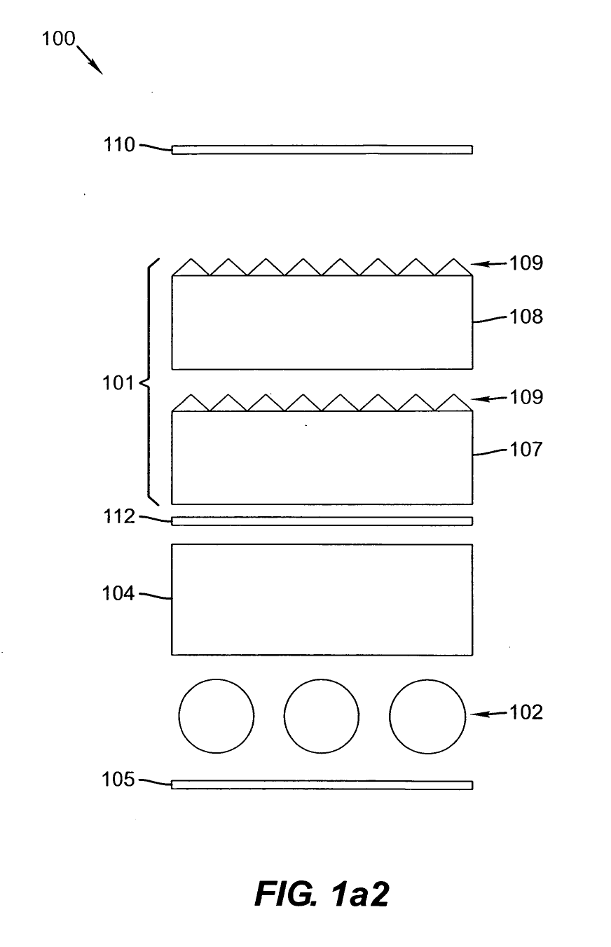

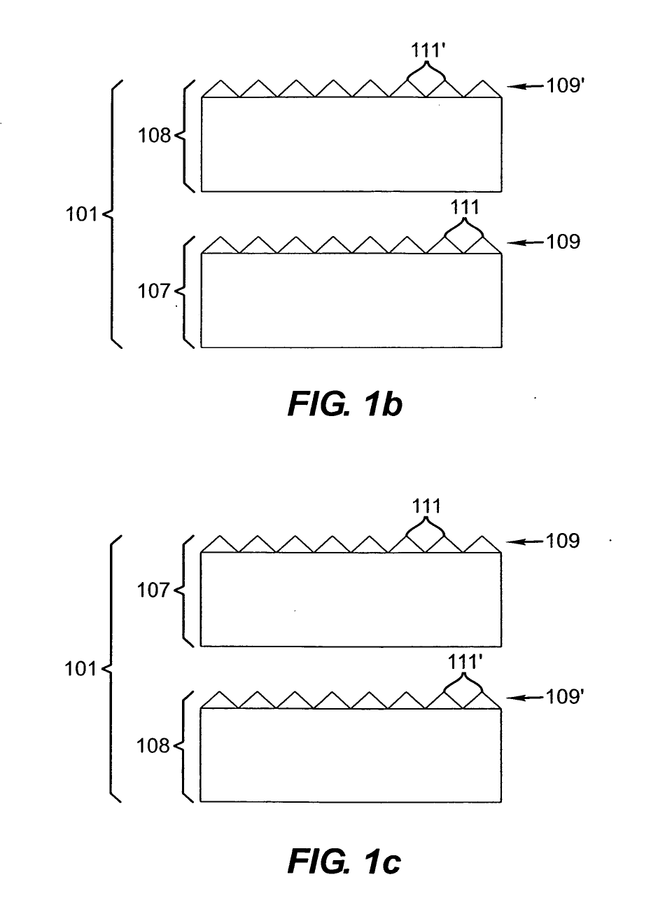

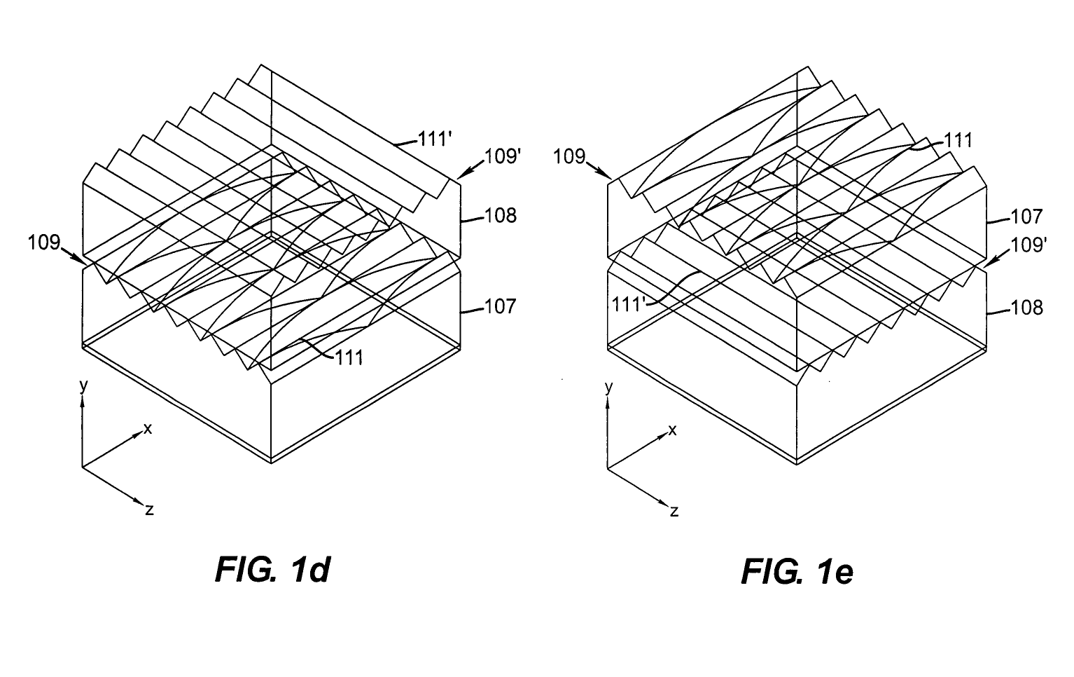

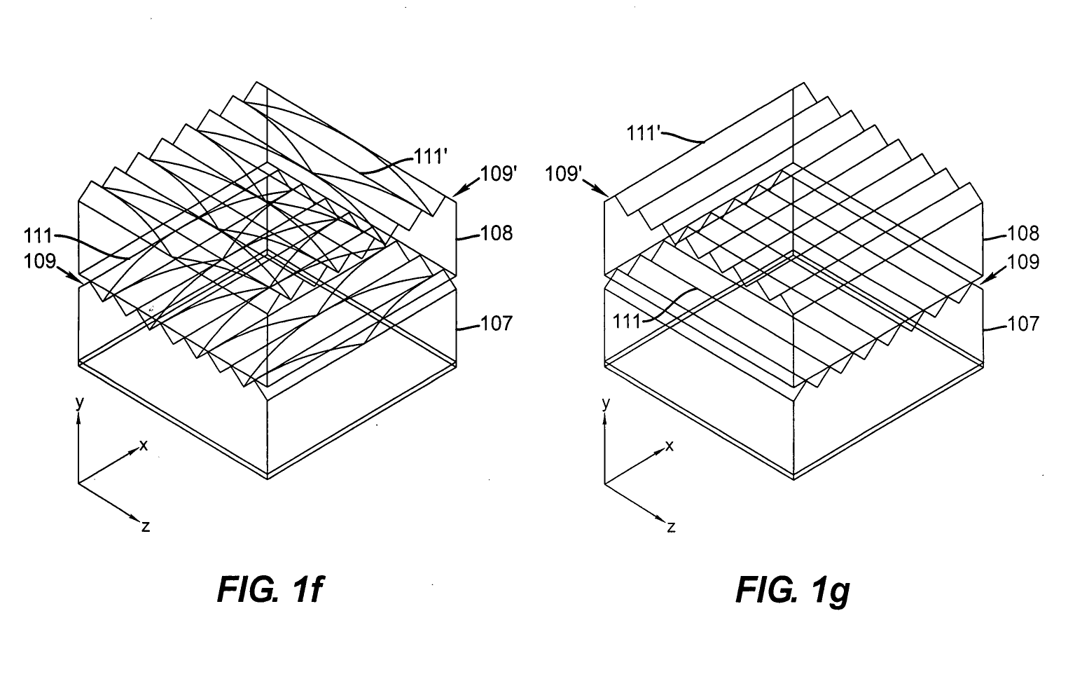

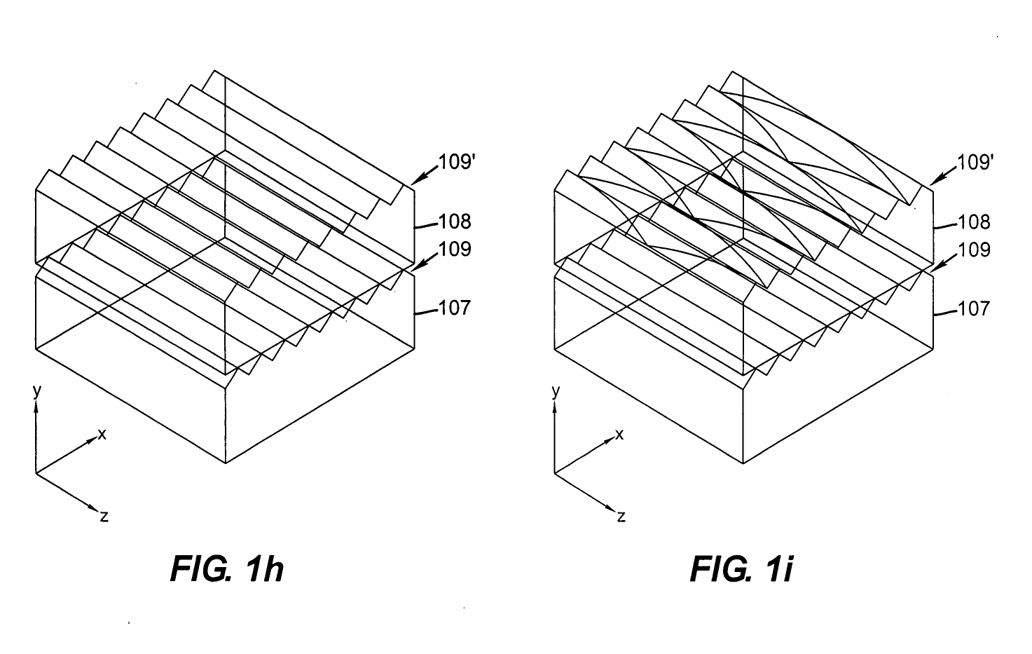

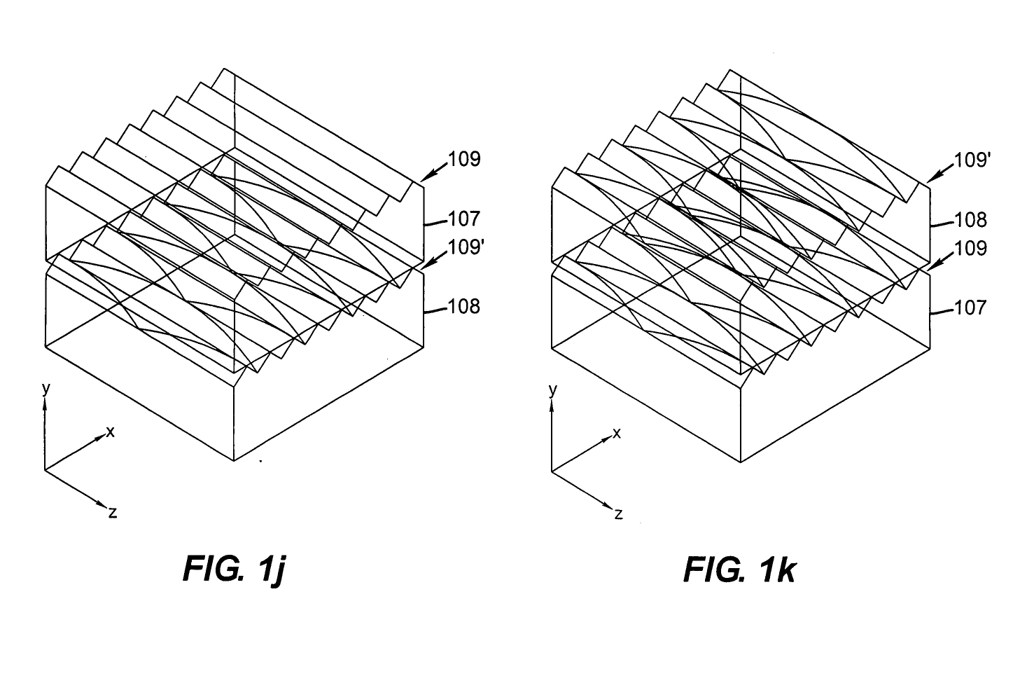

FIGS. 1a1-1a2 depict a display device 100 which includes a light management layer 101 in accordance with example embodiments. In the present example embodiments, a light source 102 and a reflective element 103 couple light to a light guide 104, which includes a reflective layer 105 disposed over at least one side as shown. As will become clearer as the present description continues, the layer 101 includes at least two films. Illustratively, the layer 101 includes a first film 107 and a second film 108. Beneficially, the first and the second film 107 and 108, respectively, each include optical features 109, which usefully direct light from the light source 102 to a light valve 110. As will become clearer as the present description continues, the optical features 109 of the present example embodiments are oriented substantially parallel to one another. In other example embodiments the optical features 109 of the first film 107 are oriented at approximately 90 degrees to the features 109 of the second film 108.

The light source 102 is typically a cold cathode fluorescent lamp (CCFL), ultra-high pressure (UHP) gas lamp, light emitting diode (LED) array, or organic LED array. It is noted that this is merely illustrative and other sources suitable for providing light in a display device may be used. FIGS. 1as and 1a2 differ in the orientation of the light sources 102 used in the display device 100; FIG. 1a1 illustrates an edge-illuminated waveguide, while FIG. 1a2 illustrates a directly-illuminated waveguide.

The light guide 104 may be of the types described in connection with one or more of the following U.S. patent applications: U.S. Ser. No. 10/857,515, filed May 28, 2004, entitled DIFFUSIVE REFLECTIVE FILMS FOR ENHANCED LIQUID CRYSTAL DISPLAY EFFICIENCY; and U.S. Ser. No. 10/857,517, filed May 28, 2004, entitled MPROVED CURL AND THICKNESS CONTROL FOR WHITE REFLECTOR FILM. The disclosures of these U.S. patent applications are specifically incorporated herein by reference. Moreover, the reflective layer 105 may be as described in connection with incorporated U.S. Ser. No. 10/857,515, filed May 28, 2004, entitled Diffusive Reflective Films for ENHANCED LIQUID CRYSTAL DISPLAY EFFICIENCY. Finally, diffusive dots (not shown) may be disposed over the light guide 104. One arrangement of diffusive dots is described in connection with incorporated U.S. U.S. Ser. No. 10/857,515, filed May 28, 2004, entitled Diffusive Reflective Films for ENHANCED LIQUID CRYSTAL DISPLAY EFFICIENCY, referenced above.

Light from the lightguide 104 is transmitted to an optional diffuser 112 that serves to diffuse the light, beneficially providing a more uniform illumination across the display surface (not shown), substantially hiding any features that are sometimes printed onto or embossed into the light guide, and significantly reducing, if not substantially eliminating, moire interference. It is noted that the diffuser 112 is known to one of ordinary skill in the art. Between the light management layer 101 and the LC panel 110, other devices may be disposed such as another diffuser or a reflective polarizer (not shown). Moreover, another polarizer (often referred to as an analyzer) may be included in the structure of the LC display 100. As many of the devices of the display 100 are well-known to one of ordinary skill in the art of LC displays many details are omitted so as to not obscure the description of the example embodiments.

FIG. 1b is a cross-sectional view of the light management layer 101 in accordance with an example embodiment. The first film 107 has a first index of refraction and the second film 108 has a second index of refraction. As described more fully herein, the light directing properties of the light management layer 101 are influenced by the magnitude of the indices of refraction, the square roots of the product of the first and second indices of refraction, and the order of the first and second films. The light directing properties are strongly influenced by the optical features that are disposed on the one or two surfaces of the light management film. The optical features may comprise symmetric or asymmetric prisms having two or more smoothly sloped facets, wedges having two more more smoothly sloped sides that may include curved surfaces, and microlenses having curved surfaces. Such optical features may fully cover the one or two surfaces of the light management film, or may be distributed so to spatially control the light transmitted or reflected by the film. Multiple features shapes, sizes, and spacings can be used in order for the light management film to direct light into the desired angular and spatial distributions. While the following examples include light management layers comprising light management films having prism-shaped or wedge-shaped features, it is understood by those skilled in the art that both prism—and wedge-shaped features can be disposed onto the same surface of a light management film. Additional shapes, sizes, and distributions of optical features can be considered that will lead to the same effect of directing light in a beneficial distribution towards a light modulating layer of an electronic display.

In the example embodiment described in connection with FIG. 1b, the first film 107 comprises optical features 109 and the second film 108 comprises optical features 109′, which are illustratively 90° prism-shaped features. The features 109 and 109′ further may comprise first ridges 111 and second ridges 111′, respectively, that are formed through intersection of two or more surfaces that form the optical features. The optical features 109 and 109′ are useful in directing light as it emerges from each layer. In example embodiments described herein, the optical features 109 of the first film 107 are substantially parallel to the first ridges 111, the optical features 109′ of the second film 109 are substantially parallel to the second ridges 111′. In certain example embodiments, the first ridges 111 are substantially parallel to the second ridges 111′. In other example embodiments, the first ridges 111 are substantially perpendicular to the second ridges 111′.

It is noted that the features 109 and 109′ may be of other shapes than of 90° prisms. For example, the features may be wedge-shaped as described in connection with U.S. patent applications: U.S. Ser. No. 10/868,689, filed Jun. 15, 2004, entitled OPTICAL FILM AND METHOD OF MANUFACTURE; U.S. Ser. No. 10/868,083, filed Jun. 15, 2004, entitled THERMOPLASTIC OPTICAL FEATURES WITH HIGH APEX SHARPNESS; and U.S. Ser. No. 10/939,769, filed Sep. 10, 2004, entitled RANDOMIZED PATTERNS OF INDIVIDUAL OPTICAL ELEMENTS. The disclosures of these applications are specifically incorporated herein by reference. Moreover, the features may be fabricated and arranged by a variety of known methods, such as UV cast and curing processes, or molding processes, or embossing processes. Notably, the features may be fabricated and arranged by methods described in the incorporated U.S. patent applications.

The first film 107, or the second film 108, or both, may be made from materials commonly used for brightness enhancement films (BEFs). These materials include, but are not limited to acrylates, polycarbonates, and other polymeric films. In addition, one or both of the films may be made from other substantially transparent optical films, including but not limited to nanocomposite materials, and optical glasses that may be patterned by molding, embossing, etching, or other processes. For example, nanocomposite materials such as described in U.S. Application Publication No. 2004-0233526, entitled OPTICAL ELEMENT WITH NANOPARTICLES, to Kaminsky et al., may be used as one or more of the light management films of the example embodiments. Illustratively, the indices of refraction of the first film 107 and the second film 108 may be in the range of approximately 1.3 to approximately 2.0 or greater, depending on the desired result.

FIG. 1c shows the light management layer 101 in accordance with another example embodiment. In the present example embodiment, the order of the first film 107 and the second film 108 is reversed. As will become clearer as the present description continues, the order of the films can be chosen to realize a desired light efficiency or a desired intensity on-axis or off axis, or a combination thereof.

FIGS. 1b and 1c both depict the films 107 and 108 comprising 2 layers; a bottom substrate layer and the surface feature layers 109 and 109′, respectively. In most general terms, the bottom substrate layer and the surface feature layer may comprise materials of two different refractive indices, or may comprise materials of substantially the same refractive index. Depiction herein of a two layered film structure is merely illustrative; it is contemplated that such a film structure may be formed of a single material via well known molding or embossing techniques. Additionally, while optical features are depicted on only one surface, this is merely illustrative as it is contemplated that optical features can be formed on opposing surfaces of the films 107 and 108. Optical features that may be formed on the surfaces of the films 107 and 108 may be the same as those represented by optical features 109 and 109′ or may otherwise include microlens elements, roughened surface features to provide light scattering, anti-reflecting surface features, and others known in the art that produce a light redirecting function.

FIGS. 1d-1k are three-dimensional views of the first and second light management films 107 and 108, respectively having optical features disposed thereover and having certain orientations relative to one another.

In an example embodiment described in connection with FIG. 1d, the first light management film 107 includes optical features 109 that are wedge-shaped; and the second light management film 108 includes optical features 109′, that are prism-shaped. In this example embodiment, the features 109 and 109′ are oriented substantially orthogonally to one another. To wit, ridges 111′ of the second film 108, which are oriented substantially parallel to the z-axis, are substantially perpendicular to ridges 11 of the first film 107, which are oriented substantially parallel to the x-axis.

In an example embodiment described in connection with FIG. 1e, the order of the films is reversed with respect to the order of the embodiment of FIG. 1d. The orientation of the ridges 111 and 111′ remains substantially orthogonal as shown.

In an example embodiment described in connection with FIG. 1f, the first film 107 has optical features 109, which are wedge-shaped as described above. The second film 108 also has features 109′, which are wedge-shaped. The ridges 111 of the features 109 of the first film 107 are substantially parallel to the x-axis; and the ridges 111′ of the features 109′ of the second film 108 are substantially parallel to the z-axis. Thus, the features 109 and ridges 111 of the first film 107 are substantially orthogonal to the features 109′ and ridges 111′ of the second film 108.

In an example embodiment described in connection with FIG. 1g, both the first film 107 and the second film 108 have prism-shaped optical features 109 and 109′. The features 109 of the first film 107 are oriented substantially orthogonal to the features 109′ of the second film 108.

In an example embodiment described in connection with FIG. 1h, the first film 107 and the second film 108 have prism-shaped features 109 and 109′. The features 109 of the first film 107 and the features 109′ of the second film 107 are oriented substantially parallel as shown.

In an example embodiment described in connection with FIG. 1i, the first film 107 has prism-shaped features 109 and the second film 108 has wedge-shaped features 109′. In this embodiment, the features 109 are substantially parallel to the features 109′ of the second film 108.

In an example embodiment described in connection with FIG. 1j, the order of the first film 107 and the second film 108 relative to the embodiment of FIG. 1h are reversed. However, the features 109 and 109′ of the respective films are oriented substantially parallel to one another.

In an example embodiment described in connection with FIG. 1k, the first film 107 and the second film 108 have wedge-shaped features 109 and 109′, respectively, which are oriented substantially parallel to one another.

It is noted that the order of the first and second films, the indices of refraction of the first and second films and the type and orientation of the optical features can be chosen to provide a variety of radiant intensity profiles at the output of a two-film light management layer. Examples of such profiles are described herein.

### EXAMPLES

### Example 1

### Crossed films with substantially the same indices of refraction

FIGS. 2a-2h are cross-sections of isocandela plots taken at approximately 0.0 degrees (vertical direction) and approximately 90.0 degrees (horizontal direction) of a light management layer comprised of two films with optical features found over at least one surface of each film. Notably, the coordinate system providing reference for the orientation of the plots is found in FIG. 11.

The light management layer used to gamer the data of FIGS. 2a-2h is illustratively the light management layer 101 of the example embodiments described in connection with FIGS. 1a-1g. Moreover, the light management layer is illustratively comprised of the first film 107 and the second film 108 of the example embodiments described in connection with FIGS. 1d-1k. It is noted that the intensity levels of FIGS. 2a-2h are measured at the output of the light management layer (i.e., prior to the light's reaching the elements beyond layer 101 of FIG. 1a).

The data depicted in each of FIGS. 2a-2h are summarized in Table 1 of FIG. 16a. This table identifies each of the curves of FIGS. 2a-2h, the type of optical feature used (prism or wedge) for each film, the refractive index of each film, the on-axis gain predicted for each film pair, RMS of the radiant intensity distribution, the FWHM of the radiant intensity distribution, and the location of the radiant intensity maximum, if located off axis (i.e., off normal). The data are further described herein.

### Examples 1a

### Two films each with prismatic optical features in orthogonal alignment as in FIG. 1g.

FIG. 2a is a cross-section of an isocandela plot at approximately 0.0 degrees showing the radiant intensity as a function of angular position for two light management films having the same indices of refraction. The light management layer giving rise to the data of FIG. 2a is comprised of the first film 107 and the second film 108 having prism-shaped optical features. The optical features are oriented substantially orthogonal to one another as depicted in FIG. 1g.

Curve 204 shows the radiant intensity distribution where both films have an index of refraction of approximately 1.70. Curve 203 shows the radiant intensity distribution where both films have an index of refraction of approximately 1.65. Curve 202 shows the radiant intensity distribution where both films have an index of refraction of approximately 1.59. Curve 201 shows the radiant intensity distribution where both films have an index of refraction of approximately 1.49. As can be appreciated, the on-axis value increases as the refractive index of each film is increased, while the full width half maximum decreases as the refractive index of each film is increased. In the examples shown here, the full width half maximum ranges from approximately 55 degrees for curve 201 to approximately 30 degrees for curve 204. Thus, the on-axis brightness is the highest for the two light management films each having an index of refraction of approximately 1.70. Moreover, the intensity of the side lobes (e.g., at approximately 50 degrees) decreases with increasing index of refraction.

FIG. 2b is a cross-section of an isocandela plot at approximately 90.0 degrees showing the radiant intensity as a function of angle. As shown in the FIG. 2b and summarized in the Table 1, the on-axis radiant intensity increases as the index of refraction is increased, and the full width half maximum ranges from approximately 52 degrees for curve 205 to approximately 29 degrees for curve 208. Thus, the on-axis brightness is the greatest for the two light management films each having an index of refraction of approximately 1.70. Moreover, the intensity of the side lobes decreases with increasing index of refraction.

FIG. 2c is a cross-section of an isocandela plot at approximately 0.0 degrees showing the radiant intensity as a function of angular position wherein curve 209 shows the radiant intensity versus angle where the first and second films both have an index of refraction of 1.75. Curve 210 shows the radiant intensity versus angle where the first and second films each have an index of refraction of 1.796. Curve 211 shows the radiant intensity versus angle where the first and second films each have an index of refraction of 1.85.

FIG. 2d is a cross-section of an isocandela plot of the film structure of FIG. 2c at approximately 90.0. Curve 212 shows the radiant intensity versus angle where the first and second films both have an index of refraction of 1.75. Curve 213 shows the radiant intensity versus angle where the first and second films each have an index of refraction of 1.796. Curve 214 shows the radiant intensity versus angle where the first and second films each have an index of refraction of 1.85.

Compared to the data of FIG. 2a-2b, the data of FIG. 2c-2d are significantly different. To this end, rather than showing a continued increase in on-axis gain there is actually a decrease in the on-axis gain with increasing index of refraction. For example, compared to the 1.70 index pair, the on-axis gain for the 1.75 pair shows a decrease and a corresponding increase in the 90 degree full width half maximum from approximately 29 degrees to approximately 35 degrees. The full width full half maximum for vertical cross-section (approximately 0.0 degrees) remains at approximately 30 degrees. At an index of 1.796 the cross-sections show a further decrease in on-axis gain while the FWHM continue to increase. A further increase in index to 1.85 shows a pronounced dip on-axis for both the 0.0 degree and 90 degree cross-sections (curves 211 and 214, respectively) and a corresponding appearance of off-axis peaks at In addition, there is an overall decrease in the radiant intensity with increasing index of refraction.

FIG. 2e shows the radiant intensity versus angle when the indices of refraction of the first film and the second film are both approximately 1.85, again for a film stack according to FIG. 1g. Curve 215 is the radiant intensity distribution at a vertical cross-section and curve 215 is the radiant distribution at horizontal cross-section.

### Examples 1b

### One film with prismatic optical features and a second light management film with wedge-shaped features in orthogonal alignment as in FIGS. 1d-e.

FIG. 2f shows the radiant intensity versus angle with the indices of refraction of the first film and the second film both being approximately 1.85. It is noted that the first film 107 of the light management layer giving rise to the data of FIG. 2f has prism-shaped optical features; and the second film 108 of the light management layer includes optical features that are wedge-shaped as shown in FIG. 1e. It is further noted that the optical features of the first film are oriented substantially orthogonal to the second film. Curve 217 is the radiant intensity distribution at a vertical cross-section and curve 218 is the radiant distribution at horizontal cross-section.

FIG. 2g shows the radiant intensity versus angle with the indices of refraction of the first film and the second film both being approximately 1.85. In this example, the order of the two films 107 and 108 are reversed in order relative to the prior example, with the film stack of this example depicted in FIG. 1d. Curve 219 is the radiant intensity distribution at a vertical cross-section and curve 220 is the radiant distribution at horizontal cross-section.

As can be readily appreciated, compared with the peak of curve 217, the peak intensity of curve 219 is greater, and a local minimum 221 (on-axis) has a higher intensity than a local minimum 222 (on-axis). Similarly, the on-axis intensity of curve 220 is greater than the on-axis intensity of curve 218. Moreover, curve 220 does not include a local minimum on-axis. Accordingly, the order of the light management films can impact the radiant distribution of light versus angle.

### Examples 1c

### Two films each with wedge-shaped optical features in orthogonal alignment as in FIG. 1f.

FIG. 2h shows the radiant intensity versus angle with the indices of refraction of the first film and the second film both being approximately 1.85. It is noted that the first film and the second film (e.g., first film 107 and second film 108 of the example embodiment of FIG. 1a) of the light management layer giving rise to the data of FIG. 2h both have wedge-shaped optical features. It is further noted that the optical features of the first film are oriented substantially orthogonal to the second film as illustrated in FIG. f. Curve 223 is the radiant intensity distribution at a vertical cross-section and curve 224 is the radiant distribution at horizontal cross-section. Clearly, the data of the vertical cross-section incurs a local minimum on-axis and the data of the horizontal cross-section is substantially constant on-axis.

### Examples Ia-Ic

### Discussion

From the example embodiments described thus far, it is clear that the light management layer 101 provides an increase in on-axis gain with increasing index of refraction of the first and second films of the layer 101 to an index limit of approximately 1.70. Moreover, when the index of refraction of the first and second films increases beyond approximately 1.8, the on-axis gain decreases, and local maxima occur at approximately ±15°. Further increasing the indices of refraction of the first and second films (e.g., to approximately 1.85) results in rather pronounced local minima, such as shown in FIGS. 2e-2h.

As can be appreciated from a review of FIGS. 2a-2h and their accompanying descriptions, in light management applications, the optical characteristics of the light management layer 101 for particular indices of refraction are useful. For example, in many display applications, it is desired to increase the on-axis gain and suppress off-axis gain (e.g., lobes at greater angles). In such instances, the layer 101 of the example embodiments of FIG. 2c or FIG. 2d may prove advantageous. The discovery of the decrease in on-axis gain and increase of the gain at approximately ±15° when the index of refraction of both the first and second films have a refractive index of 1.796 may be useful as well. For example, the relative minima (‘dip’ in on-axis gain) indicate that little or an insignificant amount of light would reach an observer looking on-axis at the display. This means that an observer cannot view the source of light if looking on-axis. Alternatively, if positioned off-axis, say looking from an angle of approximately 15-degree, the observer would see light. In certain applications it may be useful to provide such a relatively high off-axis gain and relatively low on-axis gain. For example, a display intended for viewers located at approximately ±15° would benefit from the light management layers described in connection with FIGS. 2e and 2f.

Certain aspects of the light management layer 101 comprising the first film 107 and the second film 108 are understood via analysis of the trajectories of light traversing the films 107 and 108. Some of these aspects are described in conjunction with FIGS. 3a-3f.

FIGS. 3a-3f are partial cross-sectional views of light traversing the light management layer 101 comprising first and second films 107 and 108 of example embodiments as illustrated in FIGS. 1a-1k. FIGS. 3a-3f illustrate the trajectory of light traversing the layer 101 in a reverse direction to the example embodiments of FIG. 1a (i.e., light traversing the layer 101 from the light-valve 110 to the light source 102). The reverse direction is used for simplicity of description. To wit, the trajectory of the light is from the viewer toward the light source. Due to the well-known reversibility of light, it is clear to those of ordinary skill in the optical arts that light rays that traverse an optical path from a viewer to the light source are the same light rays that will traverse an optical path from the light source to a viewer. In contrast, light rays that traverse an optical path from a viewer, but do not impinge the light source, are not representative of rays that would be emitted by the light source and directed to the viewer. In FIG. 3a, the first and second films 107 and 108, respectively, each have an index of refraction of 1.49. The on-axis light 301 in this embodiment has a trajectory that will reach the light source 102. In FIGS. 3b, the films 107, 108 each have an index of refraction of approximately 1.796, which is the threshold value discussed previously. Notably, this threshold value of the index of refraction may be approximately 1.80.

In this example, on-axis light 301 has a trajectory that will not reach the light source 102. Similarly, in the example of FIG. 3c , the first and second films each have an index of refraction of 1.85. In this embodiment, on-axis light also does not reach the light source. In fact, this light is effectively recycled to the viewer. The embodiments of FIGS. 3b and 3c illustrate that light that is on-axis cannot be from the light source. By the same token, light from the light source 102 will not be transmitted on-axis. However, in the example embodiment of FIG. 3a, on-axis light traverses to and from the light source 102.

FIGS. 3d-3f show the trajectory of light from a position 15 degrees off-axis. To wit, FIG. 3d shows the films 107, 108 each with an index of refraction of 1.49; FIG. 3e shows the films 107, 108 each with an index of refraction of 1.796; and FIG. 3f shows the films 107, 108 each with an index of refraction of 1.85. In each case, off-axis light 302 traverses the layer 101 in a trajectory that reaches the light source 102. As such, light from the light source will be transmitted off-axis. As discussed previously, the example embodiments of FIGS. 3e and 3f will provide a greater intensity of off-axis light.

Certain example embodiments described thus far have included at least two layers with the same indices of refraction. The use of the increasing indices is shown to preserve the high on-axis gain to a threshold value. When the like indices of refraction are beyond a threshold, the on-axis gain can be reduced in favor of off-axis gain. However, as described in conjunction with other example embodiments, the first and second films may have different indices of refraction. In still further example embodiments, the order of the first and second films having different indices of refraction may produce a change in the angular field of light that traverses the light management layer 101. This is an unexpected result not known in the art; the simple change in order of two light management films of differing refractive indices is sufficient to alter the angular field of view of a display without significantly altering the efficiency. Finally, as described in connection with example embodiments herein, in two-film light management layers, it has been discovered that the square root of the product of the indices of refraction is a controlling factor the radiant intensity profiles (light distribution) of the light management layer.

### Examples II

### Crossed film having different refractive indices (FIGS. 4 and 5 Tables 2&3)

FIGS. 4a-5h are graphical representations of the radiant intensity of light that traverses a variety of light management layers (e.g., layer 101) comprised of two light management films (e.g., first film 107 and second film 108) having different indices of refraction, n₁ and n₂. Data depicted in FIGS. 4a-4l are summarized in Table 2 of FIG. 16b; and data in FIGS. 5a-5h are depicted in Table 3 of FIG. 16c. It is noted that the number of light management films in the light management layer as well as the indices of refraction of the films are merely illustrative. Clearly additional light management films and films having different indices of refraction may be chosen. Beneficially, the geometric mean ((n₁×n₂)^{1/2}) of the first and second indices of refraction is less than approximately 1.80, and may be less than approximately 1.796. In certain example embodiments, the geometric mean of the indices of refraction of the first and second light management films ((n₁×n₂)^{1/2}) is less than or equal to approximately 1.635.

Notably, each of the FIGS. 4a-5h also include the case of a light management layer composed of two light management films having the same refractive indices, where the index is chosen as the geometric mean of n₁ and n₂. The reason for this choice will become clear through the ensuing examples and discussion.

### Examples IIa

### Two films each with prismatic optical features in orthogonal alignment as in FIG. 1g.

FIG. 4a shows the radiant intensity of a two-film light management layer at a vertical (0 degree) cross-section; and FIG. 4b shows the radiant intensity of the layer at a 90 degree cross-section. Illustratively, the first light management film 107 has an index of refraction (n₁) of approximately 1.49 and the second film 108 has an index of refraction (n₂ ) of approximately 1.70. Moreover, the first and second films giving rise to the data of FIGS. 4a and 4b include prism-shaped optical features that are oriented orthogonal to one another. For example, the first and second films may be as shown in and described in connection with FIG. 1g.

Curve 401 shows the intensity distribution with the first film 107, (index 1.49), disposed closest to the light guide layer 104, and thus the optical source in a display application. Curve 402 shows the intensity distribution with the order of the first and second films switched. To wit, the second light management film 108, (index 1.70), is disposed closer to the light guide 104.

Curve 403 show the radiant of intensity cross-sections at vertical cross-section where both the first film 107 and the second film 108 have the same refractive index 1.592, which is the geometric mean of the indices of the first and second films of curves 401 and 402, (i.e., (n₁×n₂)^{1/2}=1.592).

Turning to FIG. 4b curve 404 is the radiant intensity of the two film layer with the first film (n₁=1.49) closest to the light guide layer 104. Curve 405 shows the radiant intensity of light with the second film (n₂=1.70) closest to the light guide layer 104. Finally, curve 406 shows the radiant intensity along a horizontal cross-section of the light management layer 101 having two films with the same index of refraction, which equals the geometric norm of n₁ and n₂ (i.e., n_{eff}=1.592)

It is noted that the on-axis gain of curve 401 is greater than that of curve 402, and that the on-axis gain of curve 404 is greater than that of curve 405. Thus, the order of the films has an impact on the on-axis gain. Moreover, while the full width half maximum of curves 401 and 402 are nearly the same, it is observed that the full width half maximum of curve 405 is approximately 6.0 degrees greater than that of curve 404. Furthermore, the on-axis gain of curve 405 is approximately 8.0 percent less than that of curve 404. Thus, the mere transposing of the order of the first and second films of the light management layer 101 can impact the radiant distribution. As will become clearer as the present description continues, this result is more pronounced in example embodiments described herein below. Finally it is observed that if both films 107 and 108, rather having different refractive indices, actually have the same index which equals the geometric mean of 1.49 and 1.70, then the resulting radiant intensity distribution will be nearly identical to the distribution produced by a first film having index 1.70 followed by a second film having index 1.49. This result is show in FIGS. 4a and 4b, curves 403 and 406.

FIGS. 4c and 4d show the radiant intensity versus angle for 0 degree and 90 degree cross-sections, respectively, of a light management layer comprising a first light management film with an index of refraction (n₁) of approximately 1.49; and a second light management film with an index of refraction (n2) of approximately 1.85, where the geometric mean of the refractive indices of the pair of films is 1.66. The first and second films giving rise to the data of FIGS. 4c and 4d include prism-shaped optical features that are oriented orthogonal to one another. For example, the first and second films may be as shown in and described in connection with FIG. 1g.

In FIG. 4c, curve 407 shows the radiant intensity distribution with the first film 107 closest to the light guide layer 104; curve 408 shows the radiant distribution with the second film 108 closest to the light guide layer 104; and curve 409 shows the radiant intensity distribution where both the first film and the second film have an index of refraction equal to the geometric mean, n_{eff}=1.66.

In FIG. 4d, curve 410 shows the radiant intensity distribution with the first film 107 closest to the light guide layer 104; curve 411 shows the radiant distribution with the second film 108 closest to the light guide layer 104; and curve 412 shows the radiant distribution where both the first film and the second film have an index of refraction equal to the geometric mean, n_{eff}=1.66.

From FIGS. 4c and 4d it is clear that the on-axis gain of curve 407 is greater than that of curve 408; and that the on-axis gain of curve 410 is greater than that of curve 411. In the present example, the on-axis gain of curve 407 is approximately 10% greater than that of curve 408. In addition, the 90 degree full width half maximum of curve 410 is approximately 6.0 degrees smaller than that of curve 411. However, in contrast to the previous examples described in connection with FIGS. 4a and 4b, the 0 degree full width half maximum of curve 407 is approximately 2.0 degrees to 3.0 degrees smaller than that of curve 408.

FIG. 4e shows the radiant intensity of a two film light management layer at a vertical (0 degree) cross-section; and FIG. 4f shows the radiant intensity of the layer at a horizontal (90 degree) cross-section. Illustratively, the first light management film has an index of refraction (n₁) of approximately 1.59 and the second film has an index of refraction (n₂) of approximately 1.85. In addition, FIGS. 4e and 4f include a two film light management layer where the first and the second light management films have an index of refraction equal to the geometric norm of n₁ and n₂, which is 1.71. The first and second films giving rise to the data of FIGS. 4e and 4f include prism-shaped optical features that are oriented orthogonal to one another, as shown in and described in connection with FIG. 1g.

In FIG. 4e, curve 413 shows the radiant intensity distribution with the first film 107 closest to the light guide layer 104; curve 414 shows the radiant distribution with the second film 108 closest to the light guide layer 104; curve 415 shows the radiant distribution where both the first film and the second film have an index of refraction of the geometric mean, 1.71.

In FIG. 4f, curve 416 shows the radiant distribution with the first film 107 closest to the light guide layer 104; curve 417 shows the radiant distribution with the second film 108 closest to the light guide layer 104; and curve 418 shows the radiant distribution where both the first film and the second film have an index of refraction of the geometric mean, 1.71.

A review of FIG. 4e reveals a very small impact of film order upon on-axis gain and FWHM; the on-axis gains for curves 413, 414 and 415 are essentially the same as are the on-axis gains for curves 416, 417 and 418. Moreover, the radiant distributions have full width half maxima for curves 413-415 are within approximately ±2 degrees of approximately 30 degrees.

### Examples II b

### One film with prismatic optical features and a second light management film with wedge-shaped features.

FIG. 4g shows the radiant intensity of a two film light management layer at a vertical (0 degree) cross-section; and FIG. 4h shows the radiant intensity of the layer at a 90 degree cross-section. The first light management film 107 giving rise to the data of FIGS. 4g and 4h includes prism-shaped optical features, and the second light management film 108 includes wedge-shaped optical features, which are oriented substantially orthogonal to the features of the first light management film. For example, the first and second films may be as shown in and described in connection with FIGS. 1d and 1e.

Turning to FIG. 4g, curve 419 shows the radiant intensity distribution with the first film 107 closest to the light guide layer 104 and having a first index of refraction (n₁) of 1.49 and the second film 108 having a second index of refraction (n₂) of 1.70. Curve 420 the radiant intensity distribution with the second film 108 having a second index of refraction refraction (n₂) of 1.49 and the first film 107 having a first index of refraction (n₁) of 1.49. Finally, curve 421 shows the radiant intensity distribution where both the first film 107 and the second film 108 have an index of refraction of the geometric mean of 1.49 and 1.70, n_{eff}=1.592.

In FIG. 4h, curve 422 shows the radiant intensity distribution with the first film 107 closest to the light guide layer 104. The first film 107 has a first index of refraction (n₁) of 1.49 and the second film 108 having a second index of refraction (n₂) of 1.70. Curve 423 shows the radiant intensity distribution with the second film 108 having an index of refraction of 1.70 and the first film having an index of refraction of 1.49; and curve 424 shows the radiant distribution where both the first film and the second film have an index of refraction of the geometric mean, n_{eff}=1.592.

From curves 419 and 422, it is observed that the gain is slightly higher when the light impinges on the lower index film first. Correspondingly while the FWHM along the 0 degree cross-section for all three configurations is approximately 43 degrees, the FWHM for the 90 degree cross-section of is approximately 5 degrees narrower for the low-high index order.

Referring to Table 2 it is also noted that the use of a wedge-featured second film in combination with a prismatic-featured first film reduces the on-axis gain as well as the difference in on-axis gain as the indices are varied when compared to an all prismatic film system. In addition the 0 degree cross-section of the radiant intensity distribution has increased by a few degrees.

FIGS. 4i-4j show the radiant intensity distributions of a two film light management layer for three embodiments involving indices approximately equal to 1.49, 1.70 and their geometric norm, n_{eff}=1.592. In this case though, the first film 107, which is located closer to the light guide, is a wedge featured film while the second film 108 is a prismatic-featured film. Table 2 captures radiant intensity parameters.

FIG. 4i shows the radiant intensity of a two film light management layer at a vertical (0 degree) cross-section, and FIG. 4j shows the radiant intensity of the layer at a 90 degree cross-section. In addition, FIGS. 4i and 4j include data of a two film light management layer where the first and the second light management films have an index of refraction equal to the geometric norm of n₁ and n₂, which is 1.592

Turning to FIG. 4i, curve 425 shows the radiant intensity distribution with the first film 107 closest to the light guide layer 104 and having a first index of refraction (n₁) of approximately 1.49. The second film 108 has an index of refraction (n₂) of approximately 1.70. Curve 426 shows the radiant intensity distribution with first film 107 closest to the light guide layer 104. The data of curve 426 reflect the case where the first film has a first index of refraction (n₁) of approximately 1.70, and the second film 108 has an index of refraction (n₂) of approximately 1.49. Curve 427 shows the radiant intensity distribution where both the first film and the second film have an index of refraction of the geometric mean, n_{eff}=1.592.

Similarly, in FIG. 4j, curve 428 shows the radiant intensity distribution with the first film 107 closest to the light guide layer 104. The first film has an index of refraction of approximately 1.49 and the second film has an index of 1.70. Curve 429 shows the radiant intensity distribution with the second film 108 having an index of refraction of 1.49 and the first film, again closest to the light guide layer 104, having an index of refraction of 1.70. Curve 430 shows the radiant intensity distribution where both the first film and the second film have an index of refraction of the geometric mean, n_{eff}=1.592.

Again it is observed that the higher gain is obtained when the lower index film is located closest to the light guide layer 104, as shown by curves 425 and 428. The radiant intensity distribution for this arrangement is also approximately 4 degrees narrower along the 90 degree cross-section. In addition to having a higher on-axis gain for this configuration, it is observed that the combination of the wedge-featured film followed by a prismatic-featured film produces a slightly higher gain than the corresponding configuration of a prismatic-featured film followed by a wedge-featured film.

### Examples II c

### Two films each with wedge-shaped optical features.

FIG. 4k shows the radiant intensity of a two film light management layer at a vertical (0 degree) cross-section; and FIG. 4h shows the radiant intensity of the layer at a 90 degree cross-section. Illustratively, the first light management film 107 has an index of refraction (n₁) of approximately 1.49 and the second film 108 has an index of refraction (n₂) of approximately 1.70. In addition, FIGS. 4g and 4h include a two film light management layer where the first and the second light management films have an index of refraction equal to the geometric norm of n1and n2, which is 1.592. Moreover, the first and second light management films giving rise to the data include wedge-shaped optical features which are oriented substantially orthogonally to one another. For example, the first and second films may be as shown in and described in connection with FIGS. 1f.

Turning to FIG. 4k, curve 431 shows the radiant intensity distribution with the first film 107 closest to the light guide layer 104; curve 432 shows the radiant intensity distribution with the second film 108 closest to the light guide layer 104; and curve 433 shows the radiant intensity distribution where both the first film and the second film have an index of refraction of the geometric mean, 1.592.

In FIG. 4l, curve 434 shows the radiant intensity distribution with the first film 107 closest to the light guide layer 104; curve 435 shows the radiant intensity distribution with the second film 108 closest to the light guide layer 104; and curve 436 shows the radiant intensity distribution where both the first film and the second film have an index of refraction of the geometric mean, 1.592.

For this case of two wedge-featured films, curves 431 and 434 show that the on-axis gain further decreases compared with previous cases, with even less dependence in optical performance due to the order of the films. Again, the film pair that has the lower index film closest to the light guide produces the higher gain. The FWHM range from 42 to 45 degrees along the 0 degree cross-section and 41 to 45 degrees along the 90 degree radiant intensity cross-section.

### Examples IIa-IIc

### Discussion.

From the data of FIGS. 4a-4l, certain benefits of the use of a relatively high index light management film and a relatively low index light management film in a two-film light management layer of an example embodiment may be garnered. Some of these benefits are mentioned presently.

The data of FIGS. 4a-4f show that a high index film may successfully be used with a low index film without the sharp ‘dip’ in the on-axis gain of a two-film system where the indices of refraction of both the first and second light management films are relatively high (e.g., as shown in FIG. 2g). Further, the data of FIGS. 4c-4f indicate that an light management film having a relatively high index of refraction can be paired with an light management film having a relatively low index of refraction to increase the on-axis gain of the film pair. To this end, there may be a situation where it is desirable to have a two-film light management layer with one film having an index of 1.85; such as for mechanical reasons. However, the on-axis dip associated with having two films each with an index of 1.85 is not acceptable. What may be an acceptable gain, for example, would be the gain produced by two light management films each having an index equal to 1.66. In order to obtain this gain, with a two-film light management layer, while still employing one film having the desired higher index of 1.85, a second film is included that has an index equal to 1.49. It should be recognized that 1.66 is the geometric norm of 1.49 and 1.85.

As described in connection with the data of FIGS. 4c-4d, the two-film light management layer having indices of 1.85 and 1.49 no longer shows a dip in on-axis gain. In addition, the on-axis performance of such a light management layer is approximately the same as a light management layer having a pair of 1.66 index films each having an index of refraction of approximately 1.66. This is not an arbitrary choice of refractive index but rather one based on the concept of an effective refractive index. As mentioned, it has been found that the on-axis performance of two films having unequal refractive indices will be close to that of an identical pair of films if they each have a refractive index equal to the square root of the product of the high (H) and low (L) indices. For example a light management layer consisting of a first film(index 1.49) and a second film (index 1.85) , with the first film closest to the light guide layer, has an on-axis gain that is approximately 8% higher than a two-film light management layer with each film having an index of refraction of 1.66. With the second layer disposed closer to the light guide layer the on-axis gain is approximately the same the case where both films have an index of refraction of 1.66.

In addition, the order in which films of dissimilar indices are arranged can produce different on-axis gain and angular light distribution, and consequently can be used to tailor the angular performance of a display. From inspection of the data summarized in Table 2, it is noted that the greater the difference in refractive indices between the two films in the light management layer, the greater the effect the film order has on the viewing angle.

### Examples IId

### Crossed films of Effective Index 1.673

FIGS. 5a-5f and Table 3 further demonstrate how light management layers having disparate light management films of the example embodiments can provide various light distributions. FIG. 5a-5b shows the radiant intensity for a two light management film light management layer comprising a first light management film having an index of refraction n₁ and a second light management film having an index of refraction of n2. The data of FIGS. 5a-5b were calculated assuming a light management layer in which the first and second films each have prism-like features oriented substantially orthogonal to one another. For example, the first and second light management films may be as shown in the example embodiment of FIG. 1g.

FIG. 5a shows the radiant intensity versus angle for the light management layer at a vertical (0 degree) cross-section, and FIG. 5b shows the radiant intensity of the layer at a 90 degree cross-section. Illustratively, the first light management film 107 has an index of refraction (n₁) of approximately 1.40 and the second film 108 has an index of refraction (n₂) of approximately 2.00. In addition, data are given in FIGS. 5a and 5b where n₁=n₂=1.673, which is the geometric norm of 1.40 and 2.00.

Turning to FIG. 5a, curve 501 shows the intensity distribution with the first film 107 disposed closest to the light guide layer 104, and curve 502 shows the intensity distribution with the order of the first and second films switched. Curve 503 shows the intensity distribution where the first and second films each have the same index of refraction of approximately 1.673.

Similarly, in FIG. 5b, curve 504 shows the intensity distribution with the first film 107 closest to the light guide layer 104, and curve 505 shows the intensity distribution with the order of the first and second films switched. Curve 506 shows the intensity distribution where the first and second films each have an index of refraction of approximately 1.673.

It can be appreciated from the figures that the difference in on-axis gain when the films are switched in order is approximately 5%. A similar difference between curve 504, and curves 505 and 506 is observed also. The 0 degree full width half maximum ranges from approximately 26 degrees to approximately 34 degrees while the 90 degree full width maximum range is approximately 31 degree to approximately 34 degrees, depending on the order of the first and second light management films.

FIG. 5c shows the radiant intensity versus angle for a two-optical film light management layer at a vertical (0 degree) cross-section; and FIG. 5d shows the radiant intensity of the layer at a 90 degree cross-section. The data of FIGS. 5c-5d were calculated assuming a light management layer in which the first film has prism-shaped optical features and the second film has wedge-shaped optical features that are oriented substantially orthogonal to the prism shaped features of the first film. For example, the first and second light management films may be as shown in the example embodiment of FIG. 1e.

In more detail, curves 507 and 510 show the intensity distributions with the first film 107 having an index of refraction (n₁) of approximately 1.40 and the second film having an index of refraction (n₂) of approximately 2.00, for the two orthogonal cross sections. Curves 508 and 511 show the intensity distribution with the first film having an index of refraction of approximately 2.00 and the second film having an index of refraction of approximately 1.40. Curves 509 and 512 shows the intensity distribution where the first and second films each have an index of refraction of approximately n₁=n₂=1.673, which is the geometric norm of 1.40 and 2.00.

It can be appreciated from the figures that the differential between curve 507, and curves 508 and 509 is approximately 10%. A similar difference between curve 510, and curves 511 and 512 is observed as well. The 0 degree full width half maximum has a range of approximately 6.0 degrees, while the 90 degree full width maximum range is approximately 9.0 degrees, depending on the order of the first and second light management films.

FIGS. 5e and 5f show the 0 degree and 90 degree cross-sections, respectively, for a light management layer composed of one wedge-featured film and one prism-featured film wherein the wedge-featured film is located closer to the light guide layer. FIG. 1d is an illustrative example of this light management layer construction. Curves 513 and 516 show the intensity distribution with the first film 107 having an index of refraction (n₁) of approximately 1.40 and the second film having an index of refraction (n₂) of approximately 2.00. Curves 514 and 517 show the intensity distribution with the first film having an index of refraction of approximately 2.00 and the second film having an index of refraction of approximately 1.40. Curves 514 and 517 show the intensity distribution where the first and second films each have an index of refraction of approximately n₁=n₂=1.673, which is the geometric norm of the 1.40 and 2.00.

From inspection of FIGS. 5e-5F and Table 3, it is revealed that the on-axis gain has a 15% range. Further, the FWHM varies by 7 degree range in the 0 degree orientation, and 2 degrees in the 90 degree orientation.

The data set summarized in Table 3 concludes with inspection of FIGS. 5g-5h that depict the radiant intensity versus angle for a two-optical film light management layer at both vertical (0 degree) and horizontal (90 degree) cross-sections, respectively. The data of FIGS. 5g-5h were calculated assuming a light management layer in which both the first and the second light management films have wedge-shaped optical features that are oriented substantially orthogonal to one another. For example, the first and second light management films may be as shown in the example embodiment of FIG. 1f.

In FIGS. 5g and 5h, curves 519 and 522 show the intensity distribution with the first film 107 having an index of refraction (n₁) of approximately 1.40 and the second film having an index of refraction (n₂) of approximately 2.00. Curves 520 and 532 show the intensity distributions with the first film having an index of refraction of approximately 2.00 and the second film having an index of refraction of approximately 1.40. Curves 521 and 524 show the intensity distribution where the first and second films each have an index of refraction of approximately n₁=n₂=1.673, which is the geometric norm of 1.40 and 2.00.

The on-axis gain has a range of approximately 9% for these examples with two wedge-featured films. The FWHM along the 0 degree radiant intensity cross-section has a range of approximately while there is a range of approximately 1 degree in the orthogonal cross-section. Again, the data support the conclusion that the order of refractive indices of light management films impacts both on-axis gain and FWHM radiant intensity.

### Examples I-II: Discussion

In many of the example embodiments described, the light management layers comprise two light management films with optical features, such as prisms or wedges. In addition, these films are oriented relative to one another so that the optical features are substantially orthogonal to each other. It is emphasized that this is merely illustrative, and that the films may be oriented so the optical features are at one of many angles with respect to each other. For example, the light management films may be oriented so the features are substantially parallel to one another. This is illustrated for a two-film layer in FIGS. 1h-1k, which shows various combinations of prismatic and wedge featured films. These arrangements are of particular interest because the parallel orientation of the optical features enhances the prismatic bending attainable with either single or crossed films.

### Examples III

### Parallel films having the same refractive indices.

FIGS. 6a-15b are graphical representations of the radiant intensities of light through a variety of light management layers (e.g., layer 101) comprised of two light management films (e.g., first film 107 and second film 108) having different indices of refraction. FIGS. 16d-16f include Tables 4 through 6, respectively, which summarize the certain data calculated by modeling the optical performance of these light management layers. To wit, FIG. 16d depicts data, FIGS. 6a-7d; FIG. 16e depicts data of FIGS. 8a-11b; and FIG. 16e depicts data of FIGS. 12a-15b. Notably, the number of light management films in the light management layer as well as the indices of refraction of the films is merely illustrative. Clearly additional light management films and films having different indices of refraction may be chosen.

FIG. 6a shows the radiant intensity of a two film light management layer at a vertical (0 degree) cross-section, and FIG. 6b shows the radiant intensity of the layer at a 90 degree cross-section. In the present example embodiments, the index of refraction of the first light management film (n₁) is substantially the same as the index of refraction of the second light management film (n₂). Moreover, the first and second films giving rise to the data of FIGS. 6a and 6b include prism-shaped optical features that are oriented substantially parallel to one another. For example, the first and second films may be as shown and described in connection with FIG. 1h.

In detail, in FIGS. 6a and 6b, curves 601 and 605 show the intensity distributions with the first film 107 and the second film 108 each having an index of refraction (n₁) of approximately 1.49. Curves 602 and 606 show the intensity distributions with the first film and second film each having an index of refraction of approximately 1.59. Curves 603 and 607 show the intensity distributions where the first and second films each have an index of refraction of approximately 1.635; curves 604 and 608 show the intensity distributions with the first and second films each having an index of refraction of approximately 1.70.

Similar to the prior examples with crossed films (e.g., as described in connection with FIGS. 2a and 2b), as the index increases from 1.49 to 1.59 the on-axis gain increases. However, the increase is slight, consistent with the observation that while the 0 degree full width half maximum decreases dramatically from approximately 59 degrees to approximately 38 degrees, the 90-degree full half maximum increases from approximately 35 degrees to approximately 67 degrees. Although there is compression in the vertical FWHM with increasing index of refraction, there is a corresponding expansion of the FWHM in the horizontal cross-section. These two effects compensate, leading to an on-axis gain that varies only slightly with increase in film refractive index.

As can be appreciated from a review of the data of FIGS. 6a and 6b, as the index of refraction is increased beyond approximately 1.59, the on-axis gain exhibits substantially no increase. As is the case when the features of the first film are oriented substantially orthogonal to those of the second film, the on-axis gain actually decreases. This decrease is observed when the index of refraction of both films is equal to approximately 1.635. This is in contrast to the threshold index of 1.796 for crossed films. This lower threshold index for films oriented with their features parallel can be explained by an enhanced refraction by the prismatic features. For the parallel films their prismatic or wedged features are in the same direction causing additional bending of the light in the same direction. For crossed films, the prismatic or wedged features are perpendicular, thereby producing less bending by comparison. A further increase in index to a value of 1.70 actually produces a dip in the 90-degree cross-section, as shown in curve 608.

FIGS. 7a-7d show the radiant intensity for film pairs having optical features with the films oriented so the features are substantially parallel. The light management films giving rise the data of FIGS. 7a-7d both have an index of refraction of approximately 1.85. The data include examples with various pairs of films with wedge and prismatic features. In FIG. 7a, data are shown for the example embodiment where both light management films have prism-shaped features; curves 701 and 702 illustrate the radiant intensities predicted for the vertical and horizontal cross-sections, respectively. Both curves indicate a dramatic decrease (dip) in on-axis gain, with off-axis peaks appearing at approximately ±33 degrees along the vertical and approximately ±18 degrees along the horizontal.

In FIGS. 7b, similar data are shown for the example embodiment where first light management film has prism-shaped features and the second light management film has wedge-shaped features. The first film 107 is closest to the light guide layer. Curve 703 shows the data at a vertical cross-section, and curve 704 shows the data at a horizontal cross-section. Again, a pronounced dip in the on-axis gain is observed, with, peaks appearing off-axis at approximately ±33 degrees and approximately ±18 degrees.

FIGS. 7c, illustrate data for the example embodiment where the first light management film 107 has wedge-shaped optical features and is closest to the light guide layer. The second light management film 108 has prism-shaped optical features. Curve 705 shows the data at a vertical cross-section; curve 706 shows data at a horizontal cross-section. Again, a pronounced dip in the on-axis gain is observed along with the appearance of off-axis peaks.

Finally, in FIG. 7d, data are shown for the example embodiment where the first light management film 107 and the second light management film 108 both have wedge-shaped features. Curve 707 shows data for the vertical cross-section, with curve 706 illustrating data for the horizontal cross-section. Again, a pronounced dip in the on-axis gain is observed as are the off-axis peaks.

In FIGS. 7a-7d it is noted that all embodiments of the two-film light management layer produce rather similar radiant intensity patterns. Since the index is above the threshold index of 1.635, all contain a dip on-axis. However, there are strong off-axis peaks located at approximately ±33 degrees for the 0 degree cross-section and at approximately 35 18 for the 90 degree cross-section. As can be appreciated, in certain display applications, light management layers of such example embodiments will foster dual off-axis viewing applications. Finally, it is noted that this off-axis viewing is enhanced when the first film (i.e., closest to the light guide layer) has wedge-shaped optical features.

### Example IV

### Parallel films having different refractive indices.

The calculated radiant intensity of a two film light management layer the vertical (0 degree) and horizontal (90 degree) cross-sections are shown in FIGS. 8a and 8b, respectively. The refractive indices of the films and the resultant on-axis gains and FWHM light distributions are listed in Table 5 of FIG. 16e. The light management layers of the current examples comprise two light management films as shown, for example, by FIG. 1h.

In FIGS. 8a and 8b, curves 801 and 804 show data where the first film 107 has an index of refraction of approximately 1.49 and the second light management film 108 has an index of refraction of approximately 1.70. Additionally, the first light management film 107 is disposed closest to the light guide layer. Curves 802 and 805 illustrate the data calculated when the positions of the second film and the first film are switched. To wit, the second film 108 is disposed closest to the light guide layer. Finally, curves 803 and 806 show the data for the case where both films have an index of refraction of approximately 1.592, which is the geometric norm of 1.49 and 1.70.

In these examples, it is observed that the gain has approximately an 8% range. This change in gain is accompanied by more dramatic changes in the shape of the radiant intensity distributions. The 0 degree cross-sections are much smoother and have FWHM that range over a few degrees near 37 degrees. The 90 degree cross-sections have more variation. The FWHM range over 25 degrees and shows the presence of off-axis peaks whose intensity and location depend on the order of the films. The peak locations move from approximately ±21 degrees to approximately ±35 degrees as shown in curves 804 and 805 and Table 5.

FIGS. 9a and 9b depict similar data for a two film light management layer at the vertical (0 degree) and horizontal cross-sections, respectively. In the present example embodiments, the first light management film 107 has a first index of refraction (n₁) and the second light management film 108 has a second index of refraction (n₂). Moreover, the first film comprises prism-shaped optical features and the second film comprises wedge-shaped optical features. For example, the first and second films may be as shown in and described in connection with FIG. 1i.

In FIGS. 9a and 9b, curves 901 and 904 depict the calculated data where the first film 107 has an index of refraction of approximately 1.49 and the second light management film 108 has an index of refraction of approximately 1.70. Additionally, the first light management film 107 is disposed closest to the light guide layer. Curves 902 and 905 show the data where the first film has an index of refraction of approximately 1.70 and the second light management film has an index of refraction of approximately 1.49. Finally, curves 903 and 906 show the data for the case where both films have an index of refraction of approximately 1.592, which is the geometric norm of 1.49 and 1.70.

The changes to the radiant intensity are similar to those obtained with a prismatic-featured film followed by the wedge-featured film. The gain is slightly lower and the off-axis peaks move to slightly different locations. This can be observed in curves 904, 905 and 906 and is summarized by the data in Table 5.

In continuing examples, FIGS. 10a and 10b show the radiant intensity distributions of a two film light management layer at both vertical (0 degree) and horizontal (90 degree) cross-sections. In the present example embodiments, the first light management film 107 has a first index of refraction (n₁) and the second light management film 108 has a second index of refraction (n₂). Moreover, the first film has wedge-shaped optical features and the second film has prism-shaped optical features. For example, the first and second films may be as shown and described in connection with FIG. 1j.

Data from these examples are shown in FIGS. 10a and 10b, where curves 1001 and 1004 illustrate data calculated for the case where the first film 107 has an index of refraction of approximately 1.49 and the second light management film 108 has an index of refraction of approximately 1.70. Additionally, the first light management film 107 has wedge-shaped optical features and is disposed closest to the light guide layer. The second light management film 108 has prism-shaped optical features. Curves 1002 and 1005 show the data where the first and second films are reversed in order. Finally, curves 1003 and 1006 show the data for the case when both films have an index of refraction of approximately 1.592, which is the geometric norm of 1.49 and 1.70.

In these examples, the general shape of the 0 degree and 90 degree cross-sections are similar to the previous cases, although there is some redistribution of the light with changes in the FWHM that result in slightly higher on-axis gains.

Data calculated for the present examples are shown in FIGS. 11a and 11b for both the vertical (0 degree) and horizontal (90 degree) cross-sections. In the present example embodiments, the first light management film 107 has a first index of refraction (n₁) and the second light management film 108 has a second index of refraction (n₂). Moreover, the first and second films giving rise to the data of FIGS. 11a and 11b have wedge-shaped optical features that are oriented substantially parallel to one another. For example, the first and second films may be as shown and described in connection with FIG. 1k.

Turning to FIGS. 11a and 11b, curves 1101 and 1104 show calculated data where the first film 107 has an index of refraction of approximately 1.49 and the second light management film 108 has an index of refraction of approximately 1.70. Additionally, the first light management film 107 is disposed closest to the light guide layer. Curves 1102 and 1105 show the cases where these two films are reversed in order, to wit, the second film 108 is disposed closest to the light guide layer. Finally, curves 1103 and 1106 show the data for the case when both films have an index of refraction of approximately 1.592, which is the geometric norm of 1.49 and 1.70.

Referring to curves 1101 to 1106 it is again observed that those light management layer configurations with the wedge-featured film closest to the light guide produce radiant intensities that are slightly higher than those configurations that have the prismatic film closer to the light guide.

As can be appreciated, the data of FIGS. 8a-11b were calculated from example embodiments including a variety of light management layers comprising light management films having features that are substantially parallel and having differing refractive indices. In the examples provided, the indices of refraction include approximately 1.49 and approximately 1.70. Moreover, data from two films having the same index of refraction were included, with this “same” index of refraction equal to the geometric mean of 1.49 and 1.70, i.e., approximately 1.635. Of course, an index of 1.70 is above the threshold index of 1.635 observed in connection with the data of FIGS. 6a and 6b. However, in keeping with example embodiments, the light management layer structure of 1.70/1.49 films provides an effect on the radiant intensity distribution that is similar to the effect produced by the two-film light management layer wherein each film has an index of 1.592. Thus the geometric mean of the refractive indices of a pair of films is viewed as their effective index of refraction. When this effective index is below the threshold the light management layer performs in a manner similar to a layer of two films where each film has an index of 1.592.

FIGS. 12a through 15b depict a final set of examples with light management layers comprising a variety of both wedge-shaped and prism-shaped optical features, differing refractive indices, and differing orders of films. In each of these cases, the optical features of each film are oriented in parallel to one another. The data shown in FIGS. 12a and 12b correspond to a light management layer as shown and described by FIG. 1h. Further, the data shown in FIGS. 13, 14, and 15 are calculated for light management layers as depicted, for example, in FIGS. 1i, 1j, and 1k, respectively. The data of FIGS. 12a through 15b are summarized in Table 6 of FIG. 16f, where the cross-section, film indices, optical features, on-axis gain, and FWHM are tabulated. In addition, special cases are shown where the on-axis gain is reduced and off-axis peaks occur. FIGS. 12a-15b demonstrate how films having parallel features but different refractive indices can produce different light distributions. The data of these drawings were calculated using combinations of prismatic-featured and wedge-featured films, where the refractive indices are in combinations 1.40/2.00, 2.00/1.40 and their geometric norm 1.673. As such, the effective index of each pair is above the threshold index 1.635 noted previously. Again, all film combinations show similar behavior in their radiant intensity distributions. With respect to the on-axis value of the radiant intensity, the highest value is obtained when the film having the lower refractive is closest to the light guide. The next highest on-axis value is produced when the film having the higher refractive index is closest to the light guide. Finally the lowest on-axis value is produced by the configuration comprised of two films each with index equal to the effective value of 1.673.

The combinations that have a wedge-featured film first also display a somewhat higher on-axis radiant intensity. Since most of these configurations result in a local minimum on-axis for both cross-sections, they cannot be characterized by a FWHM. The 0 degree cross-section for the 2.0/1.40 ordering represents the lone exception. Here the FWHM is the neighborhood of approximately 62 degrees. The other configurations are better characterized by the appearance of off-axis peaks in their radiant intensity cross-section. From curves 1201 through 1506 and the corresponding values in Table 6 these peaks are observed at approximately ±43 degrees and approximately ±8 degrees along the 0 degree direction and at approximately ±12 degrees and approximately ±25 degrees along the 90 degree cross-section. These effects further demonstrate the ability to affect viewing angle properties through the choice of index, index order and feature orientation for the two or more films that comprise the light management layer.

In accordance with illustrative embodiments, light management layers which may be used in lighting and display applications, provide a variety of angular intensity distributions. The choice of light management films and their orientation provide a variety of tailored angular distributions of light. It is emphasized that the various methods, materials, components and parameters are included by way of example only and not in any limiting sense. Therefore, the embodiments described are illustrative and are useful in providing beneficial light distributions. In view of this disclosure, those skilled in the art can implement the various example devices and methods to effect light distributions, while remaining within the scope of the appended claims.

1. An optical layer, comprising:
a first light management film having a first index of refraction (n₁);
a second light management film having a second index of refraction (n₂), wherein the first index of refraction and the second index of refraction are not the same; and
a plurality of optical features disposed over each of the light management films.

2. The optical layer of claim 1, wherein both the first and second light management films each include a plurality of optical features.

3. The optical layer of claim 2, wherein the first film includes a first side and the second film includes a second side, and optical features are disposed over the first and second sides.

4. The optical layer of claim 2, wherein the optical features include prism-shaped features.

5. The optical layer of claim 2, wherein the optical features include wedge-shaped features.

6. The optical layer of claim 5, wherein the wedge-shaped features comprise at least one curved surface.

7. The optical layer of claim 1, wherein the first index of refraction is greater than the second index of refraction.

8. The optical layer of claim 1, wherein the second index of refraction is greater than the first index of refraction.

9. The optical layer of claim 1, wherein the first light management film, or the second light management film, or both are a nanocomposite material.

10. The optical layer of claim 1, wherein (n₁.×n₂)^{1/2} is less than or equal to 1.796.

11. The optical layer of claim 1, wherein (n₁.×n₂)^{1/2} is greater than 1.796.

12. An optical layer as recited in claim 2, wherein the first light management film includes first ridges and the second light management film includes second ridges; the optical features of the first film are substantially parallel to the first ridges and the optical features of the second film are substantially parallel to the second ridges; and the first ridges are substantially parallel to the second ridges.

13. An optical layer as recited in claim 2, wherein the first light management film includes first ridges and the second light management film includes second ridges; the optical features of the first film are substantially parallel to the first ridges and the optical features of the second film are substantially parallel to the second ridges; and the first ridges are substantially perpendicular to the second ridges.

14. An optical layer as recited in claim 1, wherein (n₁.×n₂)^{1/2} is less than or equal to approximately 1.635.

15. A display device, comprising:
a light management layer including:
a first light management film having a first index of refraction (n₁);
a second light management film having a second index of refraction (n₂), wherein the first index of refraction and the second index of refraction are not the same; and
a plurality of optical features disposed over each of the light management films.

16. The display device of claim 15, wherein (n₁.×n₂)^{1/2} is greater than 1.796.

17. The display device of claim 15, further comprising one or more light sources.

18. The display device of claim 15, further comprising a light valve.

19. The display device of claim 18, wherein the light valve is one of: a liquid crystal device (LCD); a liquid crystal on silicon (LCOS) device; or a digital light processing (DLP) light valve.

20. The display device of claim 15, wherein the first film includes a first side and the second film includes a second side, and optical features are disposed over the first and second sides.

21. The display device of claim 20, wherein the optical features are prism-shaped.

22. The display device of claim 20, wherein the optical features are wedge-shaped.

23. The display device of claim 20, wherein the first index of refraction is greater than the second index of refraction.

24. The display device of claim 20, wherein the second index of refraction is greater than the first index of refraction.

25. The display device of claim 15, wherein the display device is an edge-illuminated device.

26. The display device of claim 15, wherein the display device is a direct-illuminated device.

27. The display device of claim 17, further comprising a light guide disposed between the light source and the light management layer.

28. The display device of recited in claim 27, wherein the second index of refraction is greater than the first index of refraction and the second film is disposed between the first film and the light guide.

29. The display device of recited in claim 27, wherein the second index of refraction is less than the first index of refraction and the second film is disposed between the first film and the light guide.

30. The display device of claim 15, wherein (n₁.×n₂)^{1/2} is less than or equal to 1.796.

31. The display device of claim 15, wherein (n₁.×n₂)^{1/2} is less than approximately 1.635.

32. A display device as recited in claim 20, wherein the first light management film includes first ridges and the second light management film includes second ridges; and the optical features of the first film are substantially parallel to the first ridges and the optical features of the second film are substantially parallel to the second ridges; and the first ridges are substantially parallel to the second ridges.

33. A display device as recited in claim 20, wherein the first light management film includes first ridges and the second light management film includes second ridges; and the optical features of the first film are substantially parallel to the first ridges and the optical features of the second film are substantially parallel to the second ridges; and the first ridges are substantially perpendicular to the second ridges.

34. The display device of claim 20, wherein the plurality of features include features that are prism-shaped.

35. The display device of claim 20, wherein the plurality of features include features that are wedge-shaped.

36. An optical layer, comprising:
a first light management film having a first index of refraction (n₁);
a second light management film having a second index of refraction (n₂), wherein the first index of refraction and the second index of refraction are not the same; and
a plurality of optical features comprising wedge-shaped or prism-shaped features disposed over each of the light management films.

37. An optical layer as recited in claim 36, wherein the first light management film includes first ridges and the second light management film includes second ridges; the optical features of the first film are substantially parallel to the first ridges and the optical features of the second film are substantially parallel to the second ridges; and the first ridges are substantially parallel to the second ridges.

38. An optical layer as recited in claim 36, wherein the first light management film includes first ridges and the second light management film includes second ridges; the optical features of the first film are substantially parallel to the first ridges and the optical features of the second film are substantially parallel to the second ridges; and the first ridges are substantially perpendicular to the second ridges.

39. The optical layer of claim 36, wherein the light management films include optical features that vary in one or more of size, shape, orientation, and spacing, disposed on one or more surfaces of one or more of the light management films

40. The optical layer of claim 36, wherein the wedge-shaped features comprise at least one curved surface.

41. An optical layer, comprising:
a first light management film having a first index of refraction (n₁);
a second light management film having a second index of refraction (n₂), wherein the first index of refraction and the second index of refraction are not the same; and
a plurality of optical features comprising wedge-shaped and prism-shaped features disposed over each of the light management films.

42. An optical layer as recited in claim 41, wherein the first light management film includes first ridges and the second light management film includes second ridges; the optical features of the first film are substantially parallel to the first ridges and the optical features of the second film are substantially parallel to the second ridges; and the first ridges are substantially parallel to the second ridges.

43. An optical layer as recited in claim 41, wherein the first light management film includes first ridges and the second light management film includes second ridges; the optical features of the first film are substantially parallel to the first ridges and the optical features of the second film are substantially parallel to the second ridges; and the first ridges are substantially perpendicular to the second ridges.

44. The optical layer of claim 41, wherein the wedge-shaped features comprise at least one curved surface.

45. The optical layer of claim 41 wherein the light management films include optical features that vary in one or more of size, shape, orientation, and spacing, disposed on one or more surfaces of one or more of the light management films

46. A display device, comprising a light management layer including:
a first light management film having a first index of refraction (n₁);
a second light management film having a second index of refraction (n₂), wherein the first index of refraction and the second index of refraction are not the same; and
a plurality of optical features comprising wedge-shaped or prism-shaped features disposed over each of the light management films.

47. A display device, comprising:
a light management layer including:
a first light management film having a first index of refraction (n₁);
a second light management film having a second index of refraction (n₂), wherein the first index of refraction and the second index of refraction are not the same; and
a plurality of optical features comprising wedge-shaped and prism-shaped features disposed over each of the light management films.
